(19) United States
(12) Patent Application Publication
(10) Pub. No.: US 2026/0352357 A1
(43) Pub. Date: Nov. 5, 2026

(54) SYSTEMS, APPARATUSES, METHODS, AND COMPUTER PROGRAM PRODUCTS FOR DYNAMIC LINK SELECTION FOR SEAMLESS CONNECTIVITY

(71) Applicant: Honeywell International Inc., Charlotte, NC (US)

(72) Inventors: Nayyar Azam Khan Rao, Surprise, AZ (US); Kirupakar J, Phoenix, AZ (US); Angelo J Koutsogiannis, Gilbert, AZ (US)

(21) Appl. No.: 19/249,529

(22) Filed: Jun. 25, 2025

Related U.S. Application Data
(60) Provisional application No. 63/798,258, filed on May 1, 2025.

(51) Int. Cl. H04B 17/391; H04B 17/309; H04W 64/00; H04W 84/06

(52) U.S. Cl. CPC H04B 17/3913; H04B 17/346; H04W 64/00; H04W 84/06

(57) ABSTRACT

Embodiments of the present disclosure provide dynamic link connectivity selection. Current aircraft state dataset for an aircraft associated with an aircraft mission may be associated. At least a portion of the current aircraft state dataset may include position data for the aircraft. Current network performance data corresponding to the current aircraft state dataset may be generated. The current network performance data may indicate a network connectivity performance of a current communication network associated with the aircraft. An optimal communication network prediction for a prospective time may be generated using a network prediction model based on the current aircraft state dataset, the current network performance data, and predicted network performance dataset associated with one or more communication networks. Performance one or more prediction-based actions may be initiated based on the optimal communication network prediction.

### CROSS-REFERENCE TO RELATED APPLICATIONS

This application claims priority to U.S. Provisional Patent Application No. 63/798,258 entitled “SYSTEMS, APPARATUSES, METHODS, AND COMPUTER PROGRAM PRODUCTS FOR DYNAMIC LINK SELECTION FOR SEAMLESS CONNECTIVITY,” filed May 1, 2025, which is incorporated herein by reference in its entirety.

### TECHNOLOGICAL FIELD

Embodiments of the present disclosure generally relate to connectivity systems; and, particularly to systems, apparatuses, methods, and computer program products for dynamic link selection for seamless connectivity. Some example embodiments, relate to systems, apparatuses, methods, and computer program products for dynamic link selection for seamless connectivity during aircraft mission, aircraft missions associated with urban air mobility and unmanned systems.

### BACKGROUND

Various embodiments of the present disclosure address technical challenges related to connectivity during aircraft missions. Through applied effort, ingenuity, and innovation many deficiencies of existing systems have been solved by developing solutions that are in accordance with the embodiments as discussed herein, many examples of which are described in detail herein.

### BRIEF SUMMARY

In accordance with one aspect of the present disclosure, a computer-implemented method for dynamic link connectivity selection is provided. In some embodiments, the computer-implemented method includes identifying, by one or more processors, current aircraft state dataset for an aircraft associated with an aircraft mission, wherein at least a portion of the current aircraft state dataset comprises position data for the aircraft; generating, by one or more processors, current network performance data corresponding to the current aircraft state dataset, wherein the current network performance data indicates a network connectivity performance of a current communication network associated with the aircraft; generating, by the one or more processors and using a network prediction model, an optimal communication network prediction for a prospective time based on the current aircraft state dataset, the current network performance data, and predicted network performance dataset associated with one or more communication networks; and initiating, by the one or more processors, performance one or more prediction-based actions based on the optimal communication network prediction.

In some embodiments, the position data comprises one or more of latitude data, longitude data, altitude data, or heading data.

In some embodiments, the current network performance data comprises signal-to-noise ratio (SNR) data associated with the current communication network with respect to the aircraft.

In some embodiments, the current network performance data comprises quality of service (QoS) data associated with the current communication network with respect to the aircraft.

In some embodiments, the optimal communication network prediction comprises an optimal communication network selected from the one or more communication networks, wherein the optimal communication network satisfies one or more selection rules.

In some embodiments, the optimal communication network prediction comprises an optimal communication network selected from the one or more communication networks and is associated with a network performance data that satisfies a network performance threshold.

In some embodiments, the network prediction model is a machine learning model.

In some embodiments, a first predicted network performance data from the predicted network performance dataset comprises SNR data associated with a communication network that is different from the current communication network.

In some embodiments, initiating the performance of the one or more prediction-based actions comprises causing switching of network connection of the aircraft from the current communication network to an optimal communication network identified by the optimal communication network prediction.

In some embodiments, the position data is received from a navigation system associated with the aircraft.

In some embodiments, the current aircraft state dataset comprises a first aircraft state dataset of one or more current aircraft state datasets received during the aircraft mission.

In accordance with another aspect of the present disclosure, an apparatus for dynamic link connectivity selection is provided. The apparatus in some embodiments includes at least one processor and at least one non-transitory memory, the at least one non-transitory memory having computer-coded instructions stored thereon. The computer-coded instructions in execution with the at least one processor causes the apparatus to perform any of the example computer-implemented methods described herein. In some other embodiments, the apparatus includes means for performing each step of any of the computer-implemented methods described herein.

In accordance with another aspect of the present disclosure, a computer program product for dynamic link connectivity selection is provided. The computer program product in some embodiments includes at least one non-transitory computer-readable storage medium having computer program code stored thereon. The computer program code in execution with at least one processor is configured for performing any one or the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an example system environment within which embodiments of the present disclosure may operate.

FIG. 2 illustrates a block diagram of an example apparatus that may be specially configured in accordance with an example embodiment of the present disclosure.

FIG. 3 illustrates an example data flow diagram showing example data structures in accordance with at least one example embodiment of the present disclosure.

FIG. 4 illustrates an example framework for training a network prediction model in accordance with at least one example embodiment of the present disclosure.

FIGS. 5 and 6 illustrate a block diagram of an example edge architecture corresponding to edge environment and example data flow in accordance with at least one example embodiment of the present disclosure.

FIG. 7 illustrates an example data flow diagram showing example data structures in accordance with at least one example embodiment of the present disclosure.

FIG. 8 illustrates a flowchart including example operations of an example process for dynamic link connectivity selection in accordance with at least one example embodiment of the present disclosure.

FIG. 9 illustrates a flowchart including example operations of an example process for dynamic link connectivity selection in accordance with at least one example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the present disclosure may be embodied in many different forms and should not be construed as limited to the embodiments set forth herein, rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based on in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### Overview and Technical Improvements

Various embodiments of the present disclosure address technical challenges related to connectivity systems. With the advances in communication, there are multiple medium which may be used for communication. Vehicles (e.g., aircrafts or the like) may make use of very high frequency (VHF) communication medium; cellular communication medium such as 5G, high frequency communication, or satellite communication medium—which are generally touch to choose for optimal use (e.g., cost, signal quality, availability, operational needs, and/or the like). Detection of communication integrity and switching between networks is of growing importance in the present landscape of cyber security and compromised networks. Expensive Networks like satellite communication (SATCOM) might not be desirable all the time but might be the only network available to accomplish a mission.

Existing solutions for detection reliable communication networks (e.g., detecting reliable datalink channels) are deficient and involve cumbersome process(es), particularly for aircrafts flying in low altitude. For example, there may be interferences from buildings and other structures throughout a flight corridor for an urban air mobility (UAM), such that signal strength from a communication network (e.g., data link) is not guaranteed and may vary across geographical locations based on the aircraft state.

Thus, to address these and/or other issues related to such example solutions, example systems, apparatuses, methods, and computer program products for dynamic link selection for seamless connectivity are disclosed herein. For example, some embodiments, identify a current aircraft state dataset for an aircraft associated with an aircraft mission, where at least a portion of the current aircraft state dataset comprises position data for the aircraft. Some embodiments generate current network performance data corresponding to the current aircraft state dataset, where the current network performance data indicates a network connectivity performance of a current communication network associated with the aircraft. Some embodiments generate, using a network prediction model, an optimal communication network prediction for a prospective time based on the current aircraft state dataset, the current network performance data, and predicted network performance dataset associated with one or more communication networks. Some embodiments initiate performance of one or more prediction-based actions based on the optimal communication network prediction. Some example embodiments detect communication degradation, associated functional impact and augment/switch with alternative sources to eliminate communication loss. Some embodiments initiate performance of one or more mitigation actions.

In this regard, example embodiments, solve problems related to detection of communication integrity and network switching, compromised networks, expensive networks, CONOPS needs, signal parameters and availability of signals in space, to name a few. Accordingly, the systems, apparatuses, methods, and computer program products disclosed herein enable seamless network connectivity that operate in an efficient, sophisticated, technically, sufficient, proactive, and dynamic manner and improves a computer (e.g., including computing devices and/or systems associated with an aircraft or aircraft mission) and technology/technical fields including the technical field of aircraft mission management and control.

### Definitions

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “information,” and similar terms may be used interchangeably to refer to data capable of being transmitted, received, or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, or the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry or digital circuitry); (b) combinations of circuits and computer program product(s) comprising software or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, or the like. As a further example, as used herein, the term “circuitry” also includes an implementation comprising one or more processors or portion(s) thereof and accompanying software or firmware. As another example, the term “circuitry” as used herein also includes, for example, a baseband integrated circuit or applications processor integrated circuit for a mobile phone or a similar integrated circuit in a server, a cellular network device, other network device, or other computing device.

As used herein, a “computer-readable storage medium,” refers to a physical storage medium (e.g., volatile, or non-volatile memory device), and may be differentiated from a “computer-readable transmission medium,” which refers to an electromagnetic signal. A computer-readable storage medium may be a non-transitory medium.

As used herein, the terms “data structure,” “data object,” or “data set” refer interchangeably to data capable of being transmitted, received, or stored. For example, a predicted asset may be associated with one or more data elements or values in a computer-readable storage medium or computer-readable transmission medium, that represents content that is configured for use or display by one or more software applications, services, microservices, or the like.

As used herein, the terms “application,” “software application,” “app,” “computer program,” “service,” or similar terms refer to a computer program or group of computer programs designed to perform coordinated functions, tasks, or activities. Such computer programs may be operated by or for the benefit of a user or group of users. An application may be configured to provide access to one or more services provided by an entity. For example, an application may be configured to provide access to services provided by visual media content provider systems. An application may run on a server or group of servers, such as, but not limited to, web servers and application servers. In some embodiments, an application may be run on or across one or more other computing devices (e.g., user devices). For example, an application may be configured to be accessed via a web browser (e.g., a website accessed via the Internet using a browser), a dedicated client running on a user device, or the like. In some examples, an application may be configured for use by and interaction with one or more local, networked or remote computing devices.

The term “client computing device,” “client device” “client computing entity” and similar terms may be used interchangeably to refer to a computer comprising at least one processor and at least one memory. In some embodiments, the client computing device may further comprise one or more of: a display device for rendering one or more of a graphical user interface, a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” and the aforementioned similar terminology may refer to computer hardware or software that is configured to access a service or functionality offered by a system such as computing system 101 described herein, for example, a service or functionality that is made available by a server. Such a server may be in a different location or another computing system, in which case the client computing device may access the server by way of a network. Client computing devices may include, without limitation, smart phones, tablet computers, kiosk, terminal, laptop computers, wearables, personal computers, enterprise computers, or the like. In some examples, client computing devices, as described herein, may communicate with or otherwise access a computing system 101, via one or more networks. In some embodiments, the at least one processor and the at least one memory need not be physically co-located with other elements of the client computing device (e.g., in a terminal environment, in which a display may be separated from a server-based processor or memory).

In some embodiments, a client computing device may be associated with a particular operator. For example, a client computing device may be operated by an operator (e.g., pilot, controller, or the like) of an aircraft (e.g., including unmanned aircraft systems). In some embodiments, a client computing device may be a general purpose computing device having special purpose computer programming stored or executed thereon (e.g., a program, application, or web browser session running on a personal computer or smartphone). In some embodiments, a client computing device may be configured as a terminal or other remote viewing apparatus configured to display graphical user interfaces and associated information generated on a remote computing device. In some embodiments, a client computing device may be a special purpose computing device configured to perform the various functions described herein. Various embodiments of client computing devices may include, without limitation, smartphones, tablets, laptops, terminals, kiosks, personal computers, desktop computers, enterprise computers, or the like. Various embodiments of client computing devices may operate using different operating systems including, without limitation, IOS, ANDROID, WINDOWS, MACOS, LINUX, CHROME OS, or the like.

As used herein, the term “graphical user interface” refers to a representation of a software interface. For example, a graphical user interface may be the visual representation of a software such as a website, mobile application, desktop application, or the like, that may be used to generally interface with the software. By way of example, images, buttons, links, backgrounds, text fields, or the like, may be included within or make up a graphical user interface. In various examples, a graphical user interface may be configured for display on one or more screens (e.g., a screen of a mobile phone, a personal computer, or the like).

As used herein, the term “application programming interface” and “API” refers to a computing interface that defines indication inputs between applications, services, microservices, computing devices, repositories, or the like. An API may define formatting for one or more of a programming code call, request, function, procedure, notification, data object, data structure, or the like. Non-limiting examples of an application programming interface may include JavaScript Object Notation (JSON), Extensible Markup Language (XML), Simple Object Access Protocol (SOAP), Hypertext Markup Language (HTML), the like, or combinations thereof.

As used herein, the term “API request” refers to a structured communication sent to an API to request data or functionality. For example, the API request may be sent to an API associated with a computing system, computing device, or application, as described herein. In some examples, the API request may identify an application such as, for example, an application with respect to which the API request is intended. In some examples, the API request may be formatted according to a predefined schema, using, for example, a standard data interchange format such as JSON, XML, or the like.

As used herein, the term “repository,” “database,” and similar terms may be used interchangeably to refer to a computing location associated with a system where data is stored, accessed, modified, and otherwise maintained by the system. A repository may be used to store data in association with a data storage protocol or a query language. In certain embodiments, a repository may embody a data storage device or devices, a separate database server or servers, or as a combination of data storage devices and separate database servers. Further, in some embodiments, a repository may be embodied as a distributed repository such that some of the stored data is stored centrally in a location within the repository and other data stored in a single remote location or a plurality of remote locations. Alternatively, in some embodiments, a repository may be distributed over a plurality of remote storage locations only such as in a cloud storage environment.

As used herein, the term “machine learning model” refers to one or more processes, algorithms, or other data entity that describes parameters, hyper-parameters, defined operations, or defined mappings of a model that is configured to process one or more inputs in accordance with one or more trained parameters of the machine learning models in order to generate a prediction. An example of a machine learning model is a mathematically derived algorithm (MDA). An MDA may comprise any algorithm trained using training data to predict one or more outcome variables. Without limitation, an MDA, as used herein, may comprise machine learning frameworks including neural networks, deep neural networks, generative adversarial networks, convolutional neural networks, recurrent neural networks, large language models, generative pre-trained transformers (GPT), support vector machines, gradient boosts, decision trees, random forests, Markov models, adaptive Bayesian techniques, and statistical models (e.g., timeseries-based forecast models such as autoregressive models, autoregressive moving average models, or an autoregressive integrating moving average models). Additionally, and without limitation, an MDA, as used in the singular, may include ensembles using multiple machine learning or statistical techniques.

As used herein, the term “generative artificial intelligence model,” “generative AI model”, and similar terms may be used interchangeably to refer to one or more artificial intelligence models, including but not limited to some example machine learning models, configured to generate new outputs in response to a prompt or other input data. A generative AI model may include a large language model such as, for example, a generative pre-trained transformer (GPT) model.

As used herein the term “prompt” or “model prompt” refers to instructions or context provided to a generative AI model to guide the generative AI model's output generation. A prompt may serve as the starting point for interaction with the generative AI model, setting the stage for the type of output expected from the generative AI model or elicit an API request having a particular API schema from the generative AI model. The prompt may be a carefully engineered input to the generative AI model that encapsulates the specific requirements of an API/API schema for an application. The prompt may be implemented as text that is sent to the generative AI model. For example, the prompt may be implemented as a string of text that is sent to the generative AI model via an API associated with the generative AI model.

As used herein the term “aircraft” refers to any machine, robot, computing devices, and/or apparatus comprised of hardware, software, firmware, and/or any combination thereof, that maneuvers throughout an environment through a medium, such as air. In some contexts, the aircraft is utilized to transport objects, entities (e.g., people, animals, or other beings), and/or other onboard cargo. In some situations, the aircraft may be transporting no object except for the aircraft itself. Examples of an aircraft include airplanes, helicopters, unmanned aerial vehicles/unmanned aircraft systems (e.g., drones), vehicles configured to operate in an urban air mobility (UAM) environment, and/or the like. An aircraft is not limited to the examples listed herein and may include other types of transportation device. In some embodiments, the aircraft is configured to perform an aircraft mission (also referred to herein as a flight).

As used herein the terms “aircraft mission”, “aircraft flight”, or “flight” refer to a defined series of operations performed by the aircraft. For example, an aircraft mission/flight may include a defined series of operations performed by the aircraft to move from a first airport to a second airport. As another example, an aircraft mission/flight may include a defined series of operations performed by the aircraft to move from a home location (e.g., a docking station of a UAV) to a destination (e.g., a package drop off location) and/or from a destination location to a home location. In this regard, in some embodiments, an aircraft mission/flight may comprise the aircraft performing preflight procedures, (e.g., at the gate before a flight, at a home location of a UAV, etc.), leaving a gate or home location, taxiing, taking off (e.g., a visual-assisted automatic landing), climbing, cruising (e.g., a cruise phase between takeoff and landing where the aircraft is at a cruise altitude), descending, landing (e.g., a visual-assisted automatic landing), parking at a gate or a destination location, performing post flight procedures (e.g., at the gate after a flight, at a destination location, etc.), and/or the like. For example, an aircraft mission may include a defined series of operations that includes leaving the gate at a first airport or a docking station at a home location, taxiing to a runway at the first airport (e.g., an originating airport), taking off from the first airport or the home location, climbing (e.g., to a cruising altitude), flying (e.g., at a cruise altitude) to a second airport (e.g., a destination airport) or a destination location, descending (e.g., from a cruising altitude), landing at the second airport or a destination location, taxiing to a gate at the second airport or a destination location, and/or parking at a gate at the second airport or at a destination location.

### EXAMPLE SYSTEM ARCHITECTURE

Various embodiments of the present disclosure may be implemented as methods, apparatus, systems, computing devices, computer program products, or the like. As such, embodiments of the present disclosure may take the form of an apparatus, system, computing device, computing entity, or the like executing instructions stored on a computer-readable storage medium to perform certain steps or operations. Thus, embodiments of the present disclosure may take the form of an entirely hardware embodiment, an entirely computer program product embodiment, or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, or apparatus, systems, computing devices, computing devices, or the like carrying out instructions, operations, steps, and similar words used interchangeably (e.g., the executable instructions, instructions for execution, program code, or the like) on a computer-readable storage medium for execution. For example, retrieval, loading, and execution of code may be performed sequentially such that one instruction is retrieved, loaded, and executed at a time. In some example embodiments, retrieval, loading, or execution may be performed in parallel such that multiple instructions are retrieved, loaded, or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

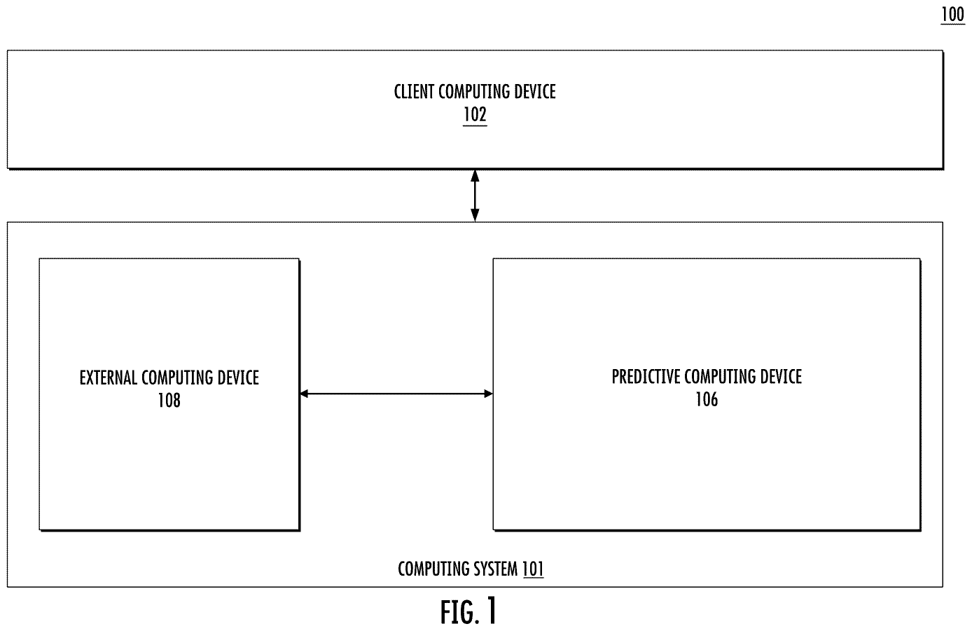

In this regard, FIG. 1 shows an example system environment 100 within which at least some embodiments of the present disclosure may operate. The depiction of the example system environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the system environment 100 disclosed therein is merely presented to provide an example basis and context for the facilitation of some of the features, aspects, and uses of the methods, apparatuses, computer readable media, and computer program products disclosed and contemplated herein.

The system environment 100 comprises a computing system 101 configured to perform dynamic link connectivity selection. For example, the computing system 101 may be configured to perform dynamic link selection for seamless connectivity for a computing device and/or a system. The example system environment 100 may be used in a plurality of domains and not limited to any specific application as disclosed herewith.

In some embodiments, the computing system 101 may communicate with one or more client computing devices 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, or firmware required to implement it (such as, e.g., network routers, or the like).

In some embodiments, the computing system 101 comprises a predictive computing device 106 (e.g., one or more servers) configured to perform various functions of the computing system 101. The predictive computing device 106 may be configured to communicate with one or more client computing devices 102 and/or one or more external computing devices 108. In some embodiments, two or more of the predictive computing device 106, client computing device(s) 102, or external computing device(s) 108 may communicate using one or more wired or wireless communication techniques. In some embodiments, two or more of the predictive computing device 106, client computing device(s) 102, or external computing device(s) 108 may be embodied by a larger system. In some examples such larger system may be associated with an urban air mobility system, an unmanned system, and/or the like.

The predictive computing device 106 may be used in a plurality of domains and not limited to any specific application as disclosed herewith. In some embodiments, the predictive computing device 106 may be utilized onboard a mobile platform such as, for example, an aircraft equipped with or otherwise associated with the predictive computing device 106. In some embodiments, the aircraft may describe any machine, robot, computing devices, and/or apparatus comprised of hardware, software, firmware, and/or any combination thereof, that maneuvers throughout an environment through a medium, such as air. In some contexts, the aircraft is utilized to transport objects, entities (e.g., people, animals, or other beings), and/or other onboard cargo. In some situations, the aircraft may be transporting no object except for the aircraft itself. Examples of the aircraft include airplanes, helicopters, unmanned aerial vehicles (e.g., drones), vehicles configured to operate in an urban air mobility (UAM) environment, and/or the like. In some embodiments, the aircraft is not limited to the examples listed herein and may include other types of transportation device.

In some embodiments, the aircraft is associated with a determinable location. The determinable location of the aircraft in some embodiments represents an absolute position (e.g., GPS coordinates, latitude and longitude locations, an address, and/or the like) or a relative position of the aircraft (e.g., an identifier representing the location of the aircraft as compared to one or more other aircraft, one or more buildings (e.g., an airport), an enterprise headquarters, or general description in the world for example based at least in part on continent, state, ocean, or other definable region). In some embodiments, the aircraft includes or otherwise is associated with a location sensor and/or software-driven location services that provide the location data corresponding to the aircraft. In other embodiments, the location of the aircraft is stored and/or otherwise determinable to one or more systems.

In some embodiments, the aircraft is configured to perform an aircraft mission (e.g., a flight mission). In some embodiments, an aircraft mission is a defined series of operations performed by the aircraft and/or one or more other aircraft. For example, an aircraft mission may include a defined series of operations performed by the aircraft and/or one or more other aircraft to move from a first airport to a second airport. As another example, an aircraft mission may include a defined series of operations performed by the aircraft and/or one or more other aircraft to move from a home location (e.g., a docking station of a UAV) to a destination (e.g., a package drop off) and/or from a destination location to a home location. In this regard, in some embodiments, an aircraft mission may include a defined series of operations performed by the aircraft that include operations performed while the aircraft and/or one or more other aircraft is performing preflight procedures, (e.g., at the gate before a flight, at a home location of a UAV, etc.), leaving a gate or home location, taxiing, taking off (e.g., a visual-assisted automatic landing), climbing, cruise (e.g., a cruise phase between takeoff and landing where the aircraft is at a cruise altitude), descending, landing (e.g., a visual-assisted automatic landing), parking at a gate or a destination location, performing post flight procedures (e.g., at the gate after a flight, at a destination location, etc.), and/or the like. For example, an aircraft mission may include a defined series of operations that includes leaving the gate at a first airport or a docking station at a home location, taxiing to a runway at the first airport (e.g., an originating airport), taking off from the first airport or the home location, climbing (e.g., to a cruising altitude), flying (e.g., at a cruise altitude) to a second airport (e.g., a destination airport) or a destination location, descending (e.g., from a cruising altitude), landing at the second airport or a destination location, taxiing to a gate at the second airport or a destination location, and/or parking at a gate at the second airport or at a destination location.

In some embodiments, the predictive computing device 106 is electronically and/or communicatively coupled to the aircraft, a client computing device 102, an external computing device 108, and/or one or more aircraft components. For example, the predictive computing device 106 may be configured to communicate with the aircraft, client computing device 102, external computing device 108, and/or one or more aircraft components using one or more wired or wireless communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, or firmware required to implement it (such as, e.g., network routers, or the like).

In some embodiments, the predictive computing device 106 is configured via hardware, software, firmware and/or a combination thereof to perform various functions associated with the predictive computing device 106, including dynamic link connectivity selection process. In some embodiments, the predictive computing device 106 is configured via hardware, software, firmware, and/or a combination thereof, to perform data intake of one or more types of data.

Additionally, or alternatively, in some embodiments, the predictive computing device 106 is configured via hardware, software, firmware, and/or a combination thereof, to generate and/or transmit command(s) and/or instruction(s) that control, adjust, or otherwise impact operations of one or more of the aircraft, the client computing device 102, external computing device 108, and/or the one or more aircraft components. For example, the predictive computing device 106 may be configured for performing dynamic link connectivity selection, as described herein. Additionally, or alternatively, in some embodiments, the predictive computing device 106 is configured via hardware, software, firmware, and/or a combination thereof, to perform data reporting, provide data, and/or other data output process(es) associated with monitoring or otherwise analyzing operations of one or more of the aircraft, the client computing device 102, the external computing device 108, and/or the one or more aircraft components. In this regard, in various embodiments, the predictive computing device 106 may be configured to execute and/or perform one or more operations and/or functions described herein.

In some embodiments, the predictive computing device 106 is a cloud-based device. In such some embodiments, the predictive computing device 106 may be located remotely from the aircraft. In this regard, for example, the predictive computing device 106 may be located in a remote cloud server and electronically and/or communicatively coupled to the aircraft, the client computing device 102, and/or the one or more aircraft components via at least the network. In some embodiments, the predictive computing device 106 is an onboard device. In some embodiments, the predictive computing device 106 may be embodied by the aircraft, the client computing device 102, or an aircraft component(s).

In some embodiments, a computing device, such as a predictive computing device 106 or external computing device 108 may comprise one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, or any combination of devices or entities adapted to perform the functions, operations, or processes described herein. Such functions, operations, or processes may comprise, for example, transmitting, receiving, operating on, processing, displaying, storing, determining, creating/generating, training one or more machine learning models or generative AI models, monitoring, evaluating, comparing, or similar terms used herein interchangeably. In some embodiments, these functions, operations, or processes may be performed on data, content, information, or similar terms used herein interchangeably. In various embodiments, the predictive computing device 106 is configured to perform an autonomous multifactor contextualized prediction process, as described herein.

The predictive computing device 106 or one or more external computing devices 108 may comprise or otherwise may be associated with storage subsystems that may be configured to store input data, training data, or the like that may be used by the respective computing devices to perform predictive data analysis or training operations of the present disclosure. In addition, the storage subsystems may be configured to store model definition data used by the respective computing devices to perform various predictive data processing or training tasks. The storage subsystem may comprise one or more storage units, such as multiple distributed storage units that are connected through a computer network. A storage unit in the respective computing devices may store at least one of one or more data assets or a set of data about the computed properties of one or more data assets. Moreover, each storage unit in the storage subsystems may comprise one or more non-volatile storage or volatile storage media similar to or different than the non-volatile or volatile computer-readable storage media discussed above.

In some example embodiments, the predictive computing device 106 may be configured to receive or transmit one or more datasets, objects, or the like from or to the external computing devices 108, client computing devices 102, aircraft, and/or aircraft components to perform one or more steps/operations of one or more techniques (e.g., data retrieval techniques or predictive data analysis techniques, dynamic link connectivity selection) described herein. The external computing devices 108, client computing devices 102, aircraft, and/or aircraft components, for example, may comprise or be associated with one or more devices that may be configured to receive, transmit, store, manage, or facilitate datasets, or the like. The external computing devices 108, client computing devices 102, aircraft, and/or aircraft components, for example, may comprise data sources that may provide such datasets, or the like to the predictive computing device 106 which may leverage the datasets to perform one or more steps/operations of the present disclosure, as described herein. In some examples, the datasets may comprise an aggregation of data from across a plurality of external computing devices 108, client computing devices 102, aircraft components, and/or other data sources into one or more aggregated datasets. The external computing devices 108, client computing devices 102, aircraft, and/or aircraft components, for example, may be associated with one or more data repositories, cloud platforms, compute nodes, organizations, or the like, which may be individually or collectively leveraged by the predictive computing device 106 to obtain and aggregate data which may be used in one or more steps/operations of the dynamic link connectivity selection process, described herein. In some examples, the datasets received from the external computing devices 108, client computing devices 102, aircraft, and/or aircraft components may be stored in one or more databases/storage units of a storage subsystem associated with the predictive computing device 106.

In some example embodiments, the predictive computing device 106 may be configured to receive one or more network prediction models generated, trained/configured and subsequently provided by the one or more external computing devices 108. For example, the one or more external computing devices 108 may be configured to perform one or more training or configuration steps/operations of the present disclosure to train or configure one or more network prediction models, as described herein. In such a case, the trained/configured network prediction model(s) may be provided to the predictive computing device 106, which may leverage the trained/configured network prediction models to perform one or more inference steps/operations of the present disclosure. In some examples, feedback (e.g., evaluation data, ground truth data) from the use of the network prediction model(s) may be received or stored by the predictive computing device 106. In some examples, the feedback may be provided to the one or more external computing devices 108 to continuously train or update the network prediction model(s) over time. In some examples, the feedback may be leveraged by the predictive computing device 106 to continuously train or update the network prediction model(s) over time. In this manner, the computing system 101 may perform, via one or more combinations of computing devices, one or more prediction, training, configuration or any other prediction-based techniques of the present disclosure.

In some embodiments, the system environment 100 includes the client computing device 102. In some embodiments, the client computing device 102 may include computer hardware or software configured to perform one or more functionalities associated with the client computing device 102. In some embodiments, the client computing device 102 may be a mobile device. For example, the client computing device 102 may be a mobile device that is capable of being held and transported by an operator. Example mobile devices include, but not limited to, smart phones, tablet computers, laptop computers, wearables, laptop computers, elements or devices interacting with such devices (e.g., web cams, microphones, etc.), or the like. In some embodiments, the client computing device 102 may be a device owned by or otherwise assigned to an operator, such as a personal mobile phone, tablet, laptop, desktop computer, or other related devices. In some embodiments, the client computing device 102 is an electronic computing device that may be used by an operator for any of a variety of purposes including, but not limited to, one or more of sending or receiving signals, storing data, displaying data, viewing data, transmitting data, receiving data, or the like. For example, a client computing device 102 may be capable of, but not limited to, one or more of displaying graphical user interfaces and other graphical representations on the screen of the client computing device 102, receiving user input (e.g., operator input), and/or the like.

The client computing device 102 may use (e.g., access or install) one or more computer program products (e.g., a mobile application platform, desktop computer application platform) configured to provide one or more functionalities of the client computing device 102. In some embodiments, the client computing device 102 hosts or is otherwise associated with one or more connected applications. In some embodiments, a connected application is a software application configured to provide one or more functionalities associated with strategic and tactical flight mission planning. For example, in some embodiments, a connected application may comprise one or more flight planning applications configured for generating flight plans and/or providing other functionalities associated with flight mission planning, including real-time modification of flight plans during the flight. For example, in some implementations a client computing device 102 may host one or more connected applications (e.g., one or more flight planning applications) that allow users (e.g., pilot) to perform various functions such as flight planning calculations, displaying navigation charts, displaying real-time weather information, and/or the like.

In some embodiments, the client computing device 102 may include a display component on which a graphical user interface may be rendered. In some embodiments, the predictive computing device 106 may be configured to transmit computer executable instructions configured to cause a graphical user interface to be rendered on the display component of the client computing device. For example, the predictive computing device 106 may be configured to command and/or control the client computing device 102 to generate a graphical user interface that includes a variety of GUI objects or elements (e.g., buttons, sliders, and the like) which may be used to prompt a user (e.g., pilot or other flight crew) to interact with the predictive computing device 106 to provide user input, and for the predictive computing device 106 to activate corresponding functions and provide user feedback, responsive to received user input at the graphical user interface element. In some embodiments, the display component may be a touch screen display.

In some embodiments, the client computing device 102 is electronically and/or communicatively coupled to the computing system 101, aircraft, the predictive computing device 106, the one or more aircraft components, and/or the one or more databases. In some embodiments, the client computing device 102 may be located remotely from the aircraft (e.g., in a control tower at an airport), in proximity of the aircraft (e.g., with a pilot at an airport gate associated with the aircraft), and/or within the aircraft (e.g., with the pilot in the aircraft). In this regard, for example, the client computing device 102 may be portable. In some embodiments, the client computing device 102 is an electronic flight bag (EFB). In some embodiments, the client computing device 102 is configured via hardware, software, firmware, and/or a combination thereof, to perform data intake of one or more types of data. In some embodiments, the client computing device 102 is an edge device. Additionally, or alternatively, in some embodiments, the client computing device 102 is configured via hardware, software, firmware, and/or a combination thereof, to generate and/or transmit command(s) that control, adjust, or otherwise impact operations of one or more of the aircraft, the predictive computing device 106, and/or the one or more aircraft components. For example, the client computing device 102 may be configured for initiating the performance of one or more prediction-based actions, one or more mitigation actions, and/or one or more aircraft mission actions. Additionally, or alternatively, in some embodiments, the client computing device 102 is configured via hardware, software, firmware, and/or a combination thereof, to perform data reporting, provide data, and/or other data output process(es) associated with monitoring or otherwise analyzing operations of one or more of the aircraft, the predictive computing device 106, and/or the one or more aircraft components. For example, in various embodiments, the client computing device 102 may be configured to execute and/or perform one or more operations and/or functions described herein. In some embodiments, the client computing device 102 comprises the predictive computing device 106. For example, in some embodiments, the client computing device 102 may embody the predictive computing device 106 and/or may be configured to perform the functions of the predictive computing device 106, as described herein. In some embodiments, the aircraft embodies the client computing device 102. For example, in some embodiments, the client computing device 102 may be onboard the aircraft.

In some embodiments, the one or more aircraft components are electronically and/or communicatively coupled to the aircraft, the external computing device 108, the predictive computing device 106, and/or the client computing device 102. The one or more aircraft components may be located within the aircraft. In this regard, for example, the one or more aircraft components may be one or more individual components of the aircraft that perform a particular function during operation of the aircraft. For example, the one or more aircraft components may include one or more of multi-function control and display units (MCDU), flight management systems (FMS), inertial reference systems (IRS), sensors, actuators, primary flight displays, radars (e.g., weather radars), engines, auxiliary power units (APU), enhanced ground proximity warning systems (EGPWS), cabin lighting, video systems, battery components, obstacle detection components, communication components, communication components, and/or the like. In this regard, for example, the individual components of the aircraft may include components associated with a particular process or operation performed by the aircraft. The one or more aircraft components, for example, may be part of an avionics system of the aircraft or represent an avionics system of the aircraft. In some embodiments, the one or more aircraft components are physically secured to the aircraft.

In some embodiments, the one or more aircraft components are configured via hardware, software, firmware, and/or a combination thereof, to perform data intake of one or more types of data. Additionally, or alternatively, in some embodiments, the one or more aircraft components are configured via hardware, software, firmware, and/or a combination thereof, to generate and/or transmit command(s) that control, adjust, or otherwise impact operations of one or more of the aircraft, the predictive computing device 106, external computing device 108, and/or the client computing device 102. Additionally, or alternatively, in some embodiments, the one or more aircraft components are configured via hardware, software, firmware, and/or a combination thereof, to perform data reporting, provide data, and/or other data output process(es) associated with monitoring or otherwise analyzing operations of one or more of the aircraft, the predictive computing device 106, external computing device 108, and/or the client computing device 102. For example, in various embodiments, the one or more aircraft components may be configured to execute and/or perform one or more operations and/or functions described herein.

In some embodiments, a client computing device 102 is an electronic computing device that may be used by an operator for any of a variety of purposes including, but not limited to, one or more of sending or receiving signals, storing data, displaying data, viewing data, transmitting data, receiving data, or the like. For example, a client computing device 102 may be capable of, but not limited to, one or more of displaying graphical user interfaces and other graphical representations on the screens of the client computing device 102, receiving operator input, or receiving operator feedback.

It will be understood that while many of the aspects and elements presented in FIG. 1 are shown as discrete, separate elements, other configurations may be used in connection with the methods, apparatuses, computer readable media, and computer programs described herein, including configurations that combine, omit, separate, or add aspects or elements. The various functions of the system environment 100 may be performed by other arrangements of one or more computing devices or computing systems without departing from the scope of the present disclosure. For example, in some embodiments, the functions of one or more of the illustrated elements in FIG. 1 may be performed by a single computing device or by multiple computing devices, which devices may be local or cloud based.

It will be appreciated that the various functions performed by two or more of the predictive computing device 106, external computing device 108, client computing device 102, or aircraft component may be embodied by a single apparatus, subsystem, or system comprising one or more sets of computing hardware (e.g., processor(s) and memory) configured to perform various functions thereof. In some embodiments, one or more intermediary devices may be positioned in electrical communication between the depicted system elements (e.g., connection between computing devices may be facilitated by various intermediary networking hardware or software elements).

In some embodiments, two or more of the depicted computing devices or computing systems may be part of a single system or device. For example, the client computing device 102 and predictive computing device 106 may be part of the same local networked system or part of the same computing system (e.g., predictive computing device 106 may be a terminal or other front end portion associated with the computing system 101 or a larger system that includes both the predictive computing device 106 and the client computing device 102). In some embodiments, two or more of the depicted devices or computing systems may be physically or electronically remote from each other (e.g., connected via the Internet).

The various elements illustrated in the system environment 100 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software or firmware required to implement it (such as, e.g., network routers, etc.). For example, the network may include a cellular telephone, an 802.11, 802.16, 802.20, or WiMAX network. Further, a network may include a public network, such as the Internet, a private network, such as an intranet, or combinations thereof, and may utilize a variety of networking protocols now available or later developed including, but not limited to TCP/IP based networking protocols.

In various embodiments, the elements depicted in FIG. 1 as being included in the computing system 101, the predictive computing device 106, external computing device, or the client computing device 102, although not required to be an integral system, may be connected via one or more networks. In some embodiments, one or more APIs may be leveraged to communicate with or facilitate communication between one or more of the elements illustrated in the computing system 101 and system environment 100.

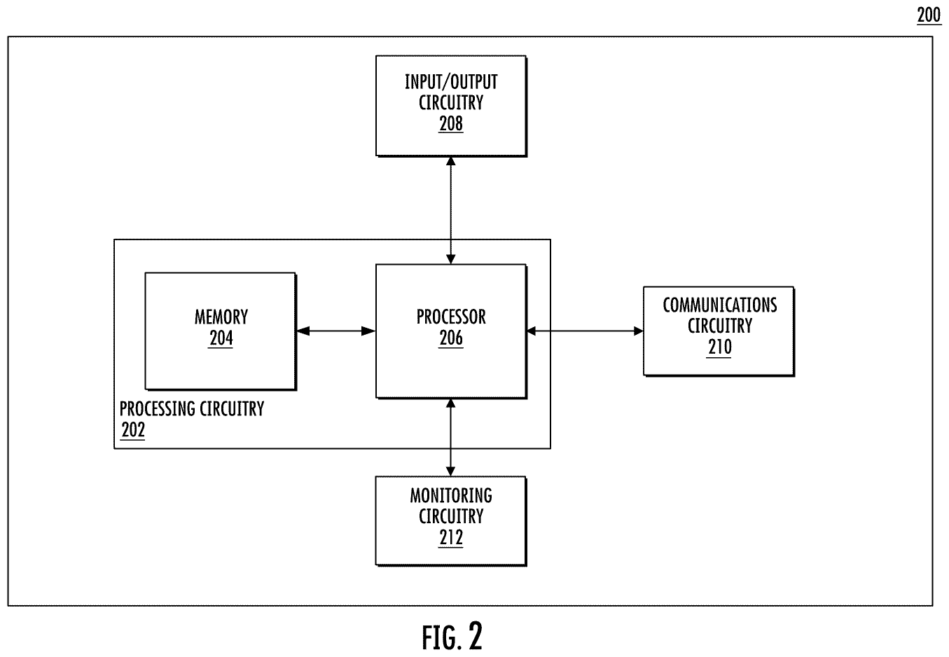

Now referencing FIG. 2, a block diagram of an apparatus 200 in accordance with at least one example embodiment of the present disclosure is provided. For example, in some embodiments, the computing system 101 or predictive computing device 106 may be embodied by one or more apparatuses 200. In this regard, in some embodiments, the computing system 101, the predictive computing device 106, or one or more portions (e.g., one or more individual elements) thereof, if embodied in a particular embodiment, may be embodied by one or more apparatuses 200.

In some embodiments, the apparatus 200 may include a processing circuitry 202 as shown in FIG. 2. In some embodiments, the elements illustrated in and described with reference to FIG. 2 below may not be mandatory and thus one or more may be omitted in certain embodiments. Additionally, some embodiments, may include further or different elements beyond those illustrated in and described with reference to FIG. 2. In some embodiments, the functionality of the computing system 101 or any subset thereof may be performed by a single apparatus 200 or multiple apparatuses 200. In some embodiments, the apparatus 200 may comprise one or a plurality of physical devices, including distributed, cloud-based, or local devices.

Although some elements are described with respect to functional limitations, it should be understood that the particular implementations necessarily include the use of particular computing hardware, such as the hardware shown in FIG. 2. It should also be understood that certain of the elements described herein may include similar or common hardware. For example, two sets of circuitries for example, may both leverage use of the same processor(s), network interface(s), storage medium(s), or the like, to perform their associated functions, such that duplicate hardware is not required for each set of circuitry and a single physical circuitry may be used to perform the functions of multiple circuitries described herein. The use of the term “circuitry” as used herein with respect to elements of the apparatuses described herein should therefore be understood to include particular hardware configured to perform the functions associated with the particular circuitry as described herein.

In some embodiments, “circuitry” may include processing circuitry, storage media, network interfaces, input/output devices, or the like. In some embodiments, other elements of the apparatus 200 may provide or supplement the functionality of another particular set of circuitry. For example, the processor 206 in some embodiments provides processing functionality to any of the sets of circuitries, the memory 204 provides storage functionality to any of the sets of circuitry, the communications circuitry 210 provide network interface functionality to any of the sets of circuitry, or the like.

The apparatus 200 may include or otherwise be in communication with processing circuitry 202 that is configurable to perform actions in accordance with one or more example embodiments disclosed herein. In this regard, the processing circuitry 202 may be configured to perform or control performance of one or more functionalities of the apparatus 200 in accordance with various example embodiments, and thus may provide means for performing functionalities of the apparatus 200 in accordance with various example embodiments. The processing circuitry 202 may be configured to perform data processing, application, and function execution, or other processing and management services according to one or more example embodiments. In some embodiments, the apparatus 200 or a portion(s) or elements(s) thereof, such as the processing circuitry 202, may be embodied as or comprise a chip or chip set. In other words, apparatus 200 or the processing circuitry 202 may comprise one or more physical packages (e.g., chips) including materials, elements or wires on a structural assembly (e.g., a baseboard). The structural assembly may provide physical strength, conservation of size, or limitation of electrical interaction for element circuitry included thereon. The apparatus 200 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein.

In some embodiments, the processing circuitry 202 may include a processor 206 (or co-processor or any other processing circuitry assisting or otherwise associated with the processor) and, in some embodiments, such as that illustrated in FIG. 2, may further include memory 204. The processing circuitry 202 may be in communication with or otherwise control a user interface (e.g., embodied by input/output circuitry 208) or a communications circuitry 210. As such, the processing circuitry 202 may be embodied as a circuit chip (e.g., an integrated circuit chip) configured (e.g., with hardware, software or a combination of hardware and software) to perform operations described herein.

The processor 206 may be embodied in a number of different ways. For example, the processor 206 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 206 may comprise a plurality of processors. The plurality of processors may be in operative communication with each other and may be collectively configured to perform one or more functionalities of the apparatus 200 as described herein. In some example embodiments, the processor 206 may be configured to execute instructions stored in the memory 204 or otherwise accessible to the processor 206. As such, whether configured by hardware or by a combination of hardware and software, the processor 206 may represent an entity (e.g., physically embodied in circuitry-in the form of processing circuitry 202) capable of performing operations according to embodiments of the present disclosure while configured accordingly. Thus, for example, when the processor 206 is embodied as an ASIC, FPGA or the like, the processor 206 may be specifically configured hardware for conducting the operations described herein. Alternatively, as another example, when the processor 206 is embodied as an executor of software instructions, the instructions may specifically configure the processor 206 to perform one or more operations described herein. The use of the terms “processor” and “processing circuitry” may be understood to include a single core processor, a multi-core processor, multiple processors internal to the apparatus 200, or one or more remote or “cloud” processor(s) external to the apparatus 200.

In some example embodiments, the memory 204 may include one or more non-transitory memory devices such as, for example, volatile or non-volatile memory that may be either fixed or removable. In this regard, the memory 204 may comprise a non-transitory computer-readable storage medium. It will be appreciated that while the memory 204 is illustrated as a single memory, the memory 204 may comprise a plurality of memories. The memory 204 may be configured to store information, data, applications, instructions or the like for enabling the apparatus 200 to carry out various functions in accordance with one or more example embodiments. For example, the memory 204 may be configured to buffer input data for processing by the processor 206. Additionally, or alternatively, the memory 204 may be configured to store instructions for execution by the processor 206. The memory 204 may include one or more databases that may store a variety of files, contents, or data sets. Among the contents of the memory 204, applications may be stored for execution by the processor 206 in order to carry out the functionality associated with each respective application. In some cases, the memory 204 may be in communication with one or more of the processors 206, input/output circuitry 208 or communications circuitry 210, via a bus(es) for passing information among elements of the apparatus 200.

The input/output circuitry 208 may provide output to the user or an intermediary device and, in some embodiments, may receive one or more indication(s) of user input directly or indirectly. In some embodiments, the input/output circuitry 208 is in communication with processor 206 to provide such functionality. The input/output circuitry 208 may include one or more user interface(s) or include a display that may comprise the user interface(s) rendered as a web user interface, an application interface, or the like, to the display of a client computing device, a backend system, or the like. The input/output circuitry 208 may be in communication with the processing circuitry 202 to receive an indication of a user input at the user interface or to provide an audible, visual, mechanical, or other output to the user. As such, the input/output circuitry 208 may include, for example, a keyboard, a mouse, a joystick, a display, a touch screen display, a microphone, a speaker, or other input/output mechanisms. As such, the input/output circuitry 208 may, in some example embodiments, provide means for a user to access and interact with the apparatus 200. The processor 206 or input/output circuitry 208 comprising or otherwise interacting with the processor 206 may be configured to control one or more functions of one or more user interface elements through computer program instructions (e.g., software or firmware) stored on a memory accessible to the processor 206 (e.g., stored on memory 204, or the like).

The communications circuitry 210 may include one or more interface mechanisms for enabling communication with other devices or networks. In some cases, the communications circuitry 210 may comprise any means such as a device or circuitry embodied in either hardware, or a combination of hardware and software that is configured to receive or transmit data from/to a network or any other device or module in communication with the processing circuitry 202. The communications circuitry 210 may, for example, include an antenna (or multiple antennas) and supporting hardware or software for enabling communications with a wireless communication network (e.g., a wireless local area network, cellular network, global positioning system network, or the like) or a communication modem or other hardware/software for supporting communication via cable, digital subscriber line (DSL), universal serial bus (USB), Ethernet or other methods.

In some embodiments, the apparatus 200 may include a monitoring circuitry 212 which may include hardware elements, with or without enabling software elements, firmware elements, or a combination thereof configured to, with the processing circuitry 202, input/output circuitry 208 or communications circuitry 210, perform one or more functions associated with the computing system 101 or predictive computing device 106 (as described above with reference to FIG. 1). For example, the monitoring circuitry 212 may access, facilitate access, receive, process, manipulate, provide, or otherwise use, or make available for use, certain data used by one or more other elements of the apparatus 200 through, for example, the use of hardware, software, applications, or APIs executed using a processor, such as the processor 206. In some embodiments, the monitoring circuitry 212 may interact with the memory 204, which may store the aforementioned data. It should also be appreciated that, in some embodiments, the monitoring circuitry 212 may include a separate processor, specially configured field programmable gate array (FPGA), or application specific interface circuit (ASIC) to receive such data utilized by the monitoring circuitry 212. The monitoring circuitry 212 may also provide for communication with other elements of the apparatus 200, system or external systems via a network interface provided by the communications circuitry 210. In some embodiments, one or more portions of the monitoring circuitry 212 and processing circuitry 202 may be integrated into a single circuitry or group of circuitries, with or without various other circuitries discussed herein, configured to execute the respective functionalities thereof.

The monitoring circuitry 212 may include software or a combination of hardware and software that supports various functionality associated with one or more network prediction models. For example, in some embodiments, the monitoring circuitry 212 includes hardware, software, firmware, or a combination thereof, configured to monitor one or more communication networks. Alternatively, or additionally, for example, in some embodiments, the monitoring circuitry 212 includes hardware, software, firmware, or a combination thereof, that performs predictive data analysis to detect a fault associated with a communication network. Alternatively, or additionally, for example, in some embodiments, the monitoring circuitry 212 includes hardware, software, firmware, or a combination thereof, that performs predictive data analysis to select an optimal communication network for a client computing device.

In this regard, FIG. 1 shows an example system environment 100 within which at least some embodiments of the present disclosure, including apparatus(es) 200, may operate. The depictions of the example system environment 100 and apparatus 200 are not intended to limit or otherwise confine the embodiments described and contemplated herein to any particular configuration of elements or systems, nor are they intended to exclude any alternative configurations or systems for the set of configurations and systems that can be used in connection with embodiments of the present disclosure. Rather, FIGS. 1-2 and the system environment 100 and apparatus(es) 200 disclosed therein are merely presented to provide an example basis and context for the facilitation of some of the features, aspects, and uses of the methods, apparatuses, computer readable media, and computer program products disclosed and contemplated herein. As noted above, in some embodiments, the predictive computing device 106 may be embodied by one or more apparatuses 200 shown in FIG. 2 or portions thereof relevant to the functions of the respective devices.

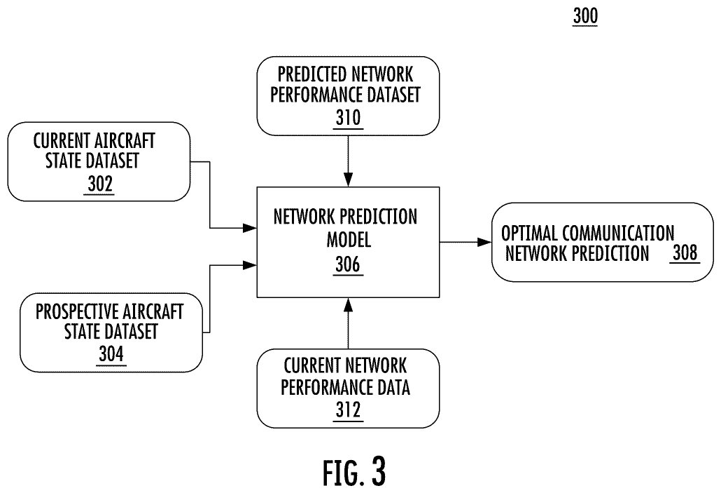

Now referencing FIG. 3, an example data flow 300 presented in accordance with at least one example embodiment of the present disclosure is provided. In some example embodiments, the data structures and processes shown and described with reference to the data flow diagram of FIG. 3 may be generated, performed, or otherwise facilitated by the various systems and apparatuses shown and described with reference to FIGS. 1-2. Using the various elements and techniques described herein, the computing system 101 (e.g., predictive computing device 106 thereof) may be configured to execute a dynamic link connectivity selection process accordingly to at least one example embodiment of the present disclosure.

In some embodiments, the computing system 101 identifies current aircraft state dataset 302 for an aircraft associated with an aircraft mission (e.g., a flight). The current aircraft state dataset 302 may be representative and/or indicative of a real-time status of the aircraft. For example, in some embodiments, the current aircraft state dataset 302 comprises real-time data for one or more operational parameters associated with the aircraft. Non-limiting examples of such operational parameters include latitude, longitude, altitude, heading (e.g., the horizontal direction of the aircraft's longitudinal axis/nose is pointing), and/or other operational parameters. In some embodiments, the current aircraft state dataset 302 comprise position data (e.g., current operational parameter data corresponding to position data) such as latitude data, longitude data, altitude data, heading data, and/or other position data for the aircraft at a particular time (e.g., current timestamp, current time period, or the like).

In some embodiments, the computing system 101 receives the aircraft state dataset 302 (or portion thereof) form one or more aircraft components. In this regard, in some embodiments, the computing system 101 receives the current aircraft state dataset 302 (or portion thereof) from a navigation system. The navigation system, for example, may be configured to provide data (including position data) associated with the aircraft's current state. In some embodiments, the navigation system may form part of a larger flight management system. In some embodiments, the navigation system may comprise inertial navigation systems, satellite navigation systems (e.g., GPS), and/or the like. For example, the navigation system may include position and direction determining equipment/component(s) capable of providing the computing system 101 with data indicative and/or representative of the current position of the aircraft (e.g., in the form of latitude, longitude, and/or the like), the position of the aircraft along its flight path, real-time direction (e.g., heading, route, track, and/or the like), and other flight operational parameter data (e.g., tilt, airspeed, altitude, and/or the like).

Alternatively or additionally, in some embodiments, the computing system 101 receives the current aircraft state dataset 302 (or portion thereof) from a sensor system. The sensor system may comprise one or more sensors that monitor the state of the aircraft during an aircraft mission/flight. Non-limiting examples of such sensors include inertial sensors, air data sensors, and/or the like. In some embodiments, the sensor system may be part of or associated with a navigation system or a flight management system, as described above.

In some embodiments, the computing system 101 may receive the current aircraft state dataset 302 as a data stream (or part thereof). For example, in some embodiments, the aircraft state dataset 302 may be configured to receive one or more current aircraft state datasets 302 over the course of the aircraft mission or otherwise during the aircraft mission, wherein each current aircraft state dataset 302 is associated with a particular time during the course of the aircraft mission. For example, in some embodiments, the computing system 101 may continuously receive data over the course of the aircraft mission or otherwise during the aircraft mission, wherein the received data (data stream) comprise and/or represents real-time aircraft state timeseries data that identifies one or more aircraft state datasets 302, each associated with a particular time over the course of, or otherwise during, the aircraft mission. In this regard, in some embodiments, the computing system 101 may receive a data stream comprising one or more current aircraft state datasets 302 from one or more aircraft components and/or sensors associated with the aircraft and during the aircraft mission. In some embodiments, the computing system 101 may be configured to parse, preprocess, and/or analyze the received data to extract or otherwise generate the current aircraft state dataset 302. In some embodiments, the computing system 101 may be configured to receive one or more current aircraft state datasets 302 periodically during the aircraft mission.

In some embodiments, the computing system 101 generates current network performance data 312. In some embodiments, the current network performance data 312 comprises one or more items of data indicative and/or representative of a performance of a communication network that is associated with the aircraft and/or the current aircraft state dataset 302. For example, the current network performance data 312 may be associated with the current aircraft state dataset 302 in that the current aircraft state dataset 302 and the current network performance data 312 may be associated with the same time stamp or time period, representative of a current time, during the aircraft mission. In some embodiments, the current network performance data 312 comprises signal-to-noise ratio (SNR) data (e.g., signal strength data), quality of service (QoS) data, and/or other performance metrics indicative of a performance of the communication network (e.g., network connectivity performance of the communication network with respect to the aircraft). In some embodiments, the SNR indicates the strength of signal(s) received from the communication network by the aircraft. In this regard, SNR may measure the power level of a received signal from a communication network. For example, the SNR may indicate the intensity of a signal(s) received from the communication network. In some embodiments, the QoS indicates the overall performance of a service (e.g., network connection service, data link service, and/or the like) provided by the communication network. In this regard, the current network performance data 312 may indicate a network connectivity performance (e.g., network connection performance) of the current communication network associated with the aircraft.

In some embodiments, current network performance data 312 comprises a network performance score indicative and/or representative of the network connectivity performance of the current communication network at the current time. In some embodiments, the current network performance data 312 comprises an SNR score indicative and/or representative of a SNR of the communication network at the current time. In some embodiments, the current network performance data 312 comprises a QoS score indicative and/or representative of a QoS of the current communication network at the current time. In this regard, the current network performance data 312 may comprise one or more of a network performance score, an SNR score, and/or a QoS score for the current communication network. In some embodiments, the network performance score for the current communication network may be generated based on the SNR score, the QoS score, and/or other performance metric scores for the current communication network. For example, the network performance score may reflect an SNR score, a QoS score, and/or other performance metric scores for the current communication network. In this regard, the current network performance data 312 may be indicative and/or representative of network connection quality or performance level of the current communication network. By way of example, the current network performance data may indicate a strong signal connection, a weak signal connection, no connection, or the like. Alternatively or additionally, the current network performance data 312 may indicate availability data for the current communication network.

In some embodiments, the computing system 101 generates the current network performance data 312 using one or more techniques. For example, the computing system 101 may generate the current network performance data 312 based on received signal strength indication (RSSI) and noise measurement. In this regard, the computing system 101 may be configured to measure the RSSI and noise at particular location and compute the difference between the RSSI value and the noise value. Other non-limiting techniques include interference analysis, effective isotropic radiated power (EIRP) computation, or the like. The computing system 101 may leverage network analyzers, network monitoring applications, spectrum analyzers, and/or other measurement devices, systems, and/or techniques to generate the current network performance data 312.

In some embodiments, the computing system 101 is configured to monitor the network connectivity for the aircraft to determine network performance data, including the current network performance data. In some embodiments, monitoring the network connectivity for the aircraft comprises monitoring the current communication network and/or other communication networks. In this regard, in some embodiments, the computing system 101 may be configured to monitor one or more communication networks from a plurality of communication networks, wherein the one or more monitored communication networks includes the current communication network associated with the aircraft.

In some embodiments, each communication network may represent or otherwise define a communication channel (e.g., a medium or communication pathway) through which data is transmitted from one device to another. For example, a communication network may define physical and/or logical connection(s) configured for exchanging data/information between two points. By way of example, a communication network may be configured to support, facilitate, and/or enable air-to-ground communication, air-to-air communication, and/or other communications between aircraft and ground systems (e.g., Air Traffic Control (ATC) and/or the like) or other aircrafts. A communication network may be used to support various services and/or communication systems such as, for example, Aircraft Communication Addressing and Reporting System (ACARS), Aeronautical Telecommunications Network (ATN), Controller-Pilot-Data-Link Communications (CPDLC), and/or the like.

A communication network may implement, comprise, utilize, or otherwise correspond to a specific data transmission technique(s) such as, for example, long term evolution (LTE), satellite communication (SATCOM), VHF data link (VDL), cellular communication network, line communication network, and/or the like. In this regard, a given communication network may implement, comprises, utilize, or otherwise correspond to LTE, SATCOM, VHF, or other data transmission techniques. SATCOM may comprise a data transmission technique that utilizes satellites and ground stations to link to voice and data networks. For example, SATCOM technique may comprise utilizing artificial satellites as relays to provide communication links between two locations. LTE may comprise a data transmission technique that utilizes land-based towers (e.g., cell towers) to transmit and receive data (e.g., within a specified range). Aircraft and/or aircraft missions may leverage communication networks to facilitate and/or enable various functions. For example, communication networks may enable efficient and accurate exchange of flight plans, clearance information, weather updates, aircraft statuses, and/or the like. In some embodiments, the plurality of communication networks comprise communication subnetworks. For example, in some embodiments, the plurality of communication networks may be part of a larger communication network, such that each of the plurality of communication networks represents a subnetwork of the larger communication network.

In some embodiments, the computing system 101, using a network prediction model 306, generates an optimal communication network prediction 308 for the aircraft for a prospective time based on the current aircraft state dataset 302, the current network performance data 312, and predicted network performance dataset 310 associated with one or more communication networks. In some embodiments, the optimal communication network prediction 308 comprises a communication network selected from one or more communication networks as the optimal communication network for the prospective time. For example, the selected communication network may comprise a communication network, of the one or more communication networks that satisfies one or more selection rules/criteria and/or associated with a network performance data for the prospective time that satisfies a network performance threshold. In this regard, the optimal communication network prediction 308 may comprise a communication network determined by the computing system 101 as the optimal communication network for connecting to the aircraft. For example, the optimal communication network may server to provide optimal network connectivity for the aircraft.

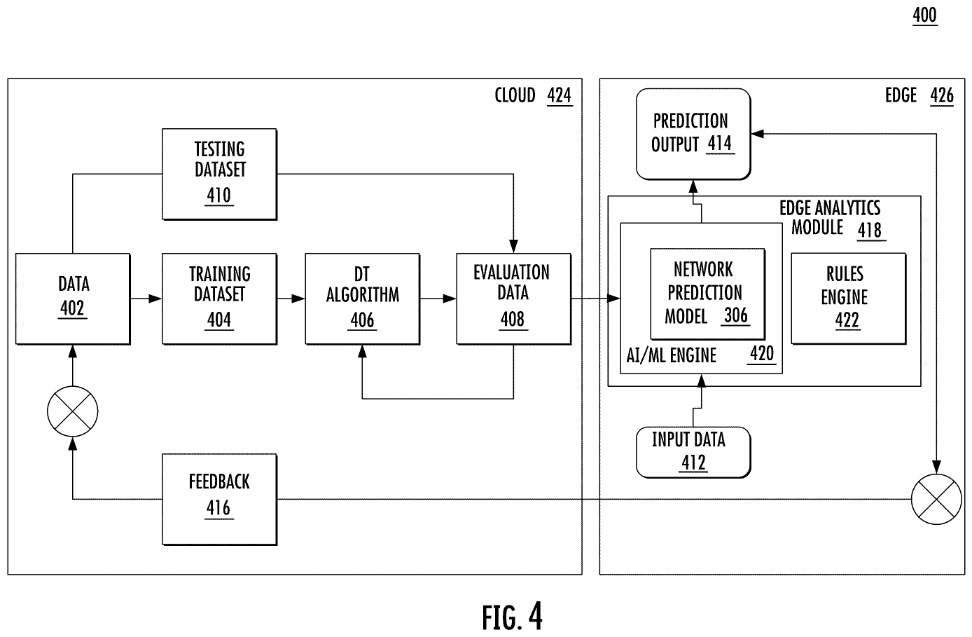

In some embodiments, the network prediction model 306 is a machine learning model. The machine learning model may be trained using one or more techniques such as, for example, as described in FIG. 4 below. The network prediction model 306 may comprise one or more machine learning algorithms. For example, the network prediction model 306 may comprise one or more of decision tree algorithm(s), naive bayes algorithm(s), support vector machine (SVM) algorithm(s), K-nearest neighbors (KNN) algorithm(s), support vector regression (SVR) algorithm(s), random forest (RF) algorithm(s), adaptive boosting (AdaBoost) algorithm(s), gradient boosting algorithm(s) such as gradient tree boosting (GTB), and/or other machine learning algorithms.

In some embodiments, the prospective time comprises a specific point in time (e.g., timestamp) or time window ahead of a prediction time at which a network prediction task is performed. For example, the prediction time may correspond to the current time, as described above. In this regard, in some embodiments, the prediction time may serve as a reference point used by the computing system 101 and/or network prediction model 306 to determine the prospective time associated with particular network prediction task. In this regard, the prediction time may represent a parameter of the computing system 101 and/or network prediction model 306 with respect to generating the optimal communication network prediction 308 for a particular network prediction network task. For example, the computing system 101 may be configured to perform (e.g., using the network prediction model) one or more network prediction task during an aircraft mission to generate an optimal communication network prediction 308 for each network prediction task. In some embodiments, the prediction time serves as a reference point from which the computing system 101 and/or network prediction model 306 looks ahead to gather, receive, and/or retrieve relevant data for generating the predicted network performance dataset 310. In this regard, the computing system 101, using a network prediction model 306, may be configured to predict an optimal communication network for a prospective portion of an aircraft mission based on current aircraft state dataset 302, current network performance data 312, and/or predicted network performance dataset 310.

In some embodiments, the predicted network performance dataset 310 comprises predicted network performance data for each of one or more communication networks. In some embodiments, the one or more communication networks includes the current communication network (e.g., communication network currently associated with the aircraft). In some embodiments, the one or more communication networks may comprise available communication networks that may be connected to the aircraft to facilitate and/or enable one or more functions of the aircraft such as, for example, flight plan updates, situational awareness, and/or other functions.

In some embodiments, a predicted network performance data from the predicted network performance dataset 310 comprises one or more items of data indicative and/or representative of a performance of the respective communication network (e.g., available communication network). In some embodiments, predicted network performance data for a communication network comprises signal-to-noise ratio (SNR) data (e.g., signal strength data), quality of service (QoS) data, and/or other performance metrics indicative of a performance of the communication network, as described above. In this regard, predicted network performance data associated with a communication network may indicate a network connectivity performance of the communication network for the prospective time.

In some embodiments, predicted network performance data comprises a predicted network performance score indicative and/or representative of a predicted performance of the respective communication network for the prospective time. In some embodiments, predicted network performance data comprises a predicted SNR score indicative and/or representative of a predicted SNR of the communication network for the prospective time. In some embodiments, the predicted network performance data comprises a predicted QoS score indicative and/or representative of a predicted QoS of the communication network for the prospective time. In this regard, the predicted network performance data may comprise one or more of a predicted network performance score, a predicted SNR score, and/or a predicted QoS score. In some embodiments, the predicted network performance score may be generated based on the predicted SNR score, the predicted QoS score, and/or other performance metric scores. For example, the predicted network performance score may reflect a predicted SNR score, a predicted QoS score, and/or other performance metric scores.

In this regard, a predicted network performance data from the predicted network performance dataset 310 may be indicative and/or representative of predicted network connection quality or performance level of a communication network over the prospective time (e.g., during a future time period) if the aircraft is connected to the communication network. By way of example, a predicted network performance data may indicate a strong signal connection, a weak signal connection, no connection, or the like. Alternatively or additionally, a predicted network performance data may comprise availability data for each of the one or more communication networks indicative and/or representative of the availability of the respective communication network for connecting to the aircraft over the prospective time.

In some embodiments, the computing system 101 generates the respective predicted network performance data of the predicted network performance dataset 310 using one or more techniques. In some embodiments, the predicted network performance dataset 310 corresponds to a prospective aircraft state dataset 304 associated with the prospective time. In some embodiments, the computing system 101 may generate the predicted network performance dataset 310 based at least in part on the prospective aircraft state dataset 304. For example, in some embodiments, a machine learning model may be trained based on historical data associated with a plurality of previous aircraft missions to generate predicted network performance dataset 310 based on input data that includes prospective aircraft state dataset 304. In some embodiments, the machine learning model may be the network prediction model 306. In some embodiments, generating the predicted network performance data for a communication network comprise performing one or more interpolation operations based on previous network performance data and/or other relevant data associated with the respective communication network. In some embodiments, generating the predicted network performance dataset 310 comprises receiving data from one or more data sources indicative of the predicted network performance data for a communication network or that may be used by the computing system 101 to compute the predicted network data.

The prospective aircraft state dataset 304 may be representative and/or indicative of a predicted status of the aircraft with respect to a prospective time. For example, the prospective aircraft state dataset 304 may comprise predicted data for one or more operational parameters (e.g., latitude, longitude, altitude, heading, and/or other operational parameters) associated with the aircraft for a prospective time. Non-limiting examples of such operational parameters include latitude, longitude, altitude, heading (e.g., the horizontal direction of the aircraft's longitudinal axis/nose is pointing), and/or other operational parameters. In some embodiments, the prospective aircraft state dataset 304 comprise predicted position data such as predicted latitude data, predicted longitude data, predicted altitude data, predicted heading data, and/or other predicted position data for the aircraft with respect to a prospective time. In this regard, in some embodiments, the prospective aircraft state dataset 304 comprises predicted operational parameter data for the aircraft for a prospective time relative to the current time associated with the current aircraft state dataset 302). By way of example, the prospective time may be N seconds ahead relative to the current time. Said differently, the current time may precede the prospective time by N seconds. In this regard, in some embodiments, the computing system 101 may identify the prospective aircraft state dataset 304 for the aircraft based on a predetermined time period (e.g., N second, where N=0.5, 20, 50, 1000, or the like) from the current time.

In some embodiments, the computing system 101 initiates the performance of one or more prediction-based actions based on the optimal communication network prediction 308. In some embodiments, initiating the performance of the one or more actions comprises causing switching of the aircraft from the current communications network to the optimal communication network identified by the optimal communication network prediction. In some embodiments, the computing system 101 may be configured to switch or cause switching of the aircraft to the optimal communication network of the one or more communication networks in response to determining that the optimal communication network is different from the current communication network. In some embodiments, the computing system 101 may be configured to switch or cause switching of the aircraft to the optimal communication network using a network switching logic. For example, the computing system 101 may be configured to transmit one or more computer-executable instructions configured to control and/or direct one or more components associated with the aircraft to switch network connection of the aircraft from the current communication network to the optimal communication network identified by the optimal communication network prediction 308 in response to determining that the optimal communication network is different from the current communication network and/or using a network switching logic.

Now referencing FIG. 4, an example framework 400 for training a network prediction model, such as network prediction model 306, in accordance with at least one example embodiment of the present disclosure is provided. In some embodiments, the network prediction model 306 is generated and/or trained using training dataset 404 aggregated from data 402 associated with a plurality of historical aircraft missions (e.g., previous aircraft missions). For example, the training dataset 404 may comprise historical aircraft state dataset for each historical aircraft mission of the plurality of historical aircraft missions. In some embodiments, the historical aircraft state dataset associated with an historical aircraft mission comprises latitude data during the historical aircraft mission, longitude data during the aircraft mission, heading data during the aircraft mission, altitude data during the aircraft mission; contextual weather data during the aircraft mission; operational flight plan for the aircraft mission, operational flight corridor plan for the aircraft mission, signal strength data (e.g., data link signal strength) during aircraft mission; and/or other aircraft state data.

In some embodiments, historical aircraft state dataset may comprise or otherwise implemented as timeseries data. For example, in some embodiments, historical aircraft state dataset may be represented as a continuous timeseries aircraft state data, wherein each time stamp of one or more timestamps defined by the timeseries data may be associated with aircraft state dataset corresponding to the timestamp during the historical aircraft mission.

As illustrated in FIG. 4, in some embodiments, the network prediction model 306 may be trained in a cloud environment (e.g., cloud server) and deployed in an edge environment (e.g., edge server). In some embodiments, the network prediction model 306 is continually and/or periodically fine-tuned (e.g., re-trained, refined, or similar terms) using recent historical aircraft state data (e.g., historical aircraft state data associated with recent aircraft missions not previously included in the training data used to previously train or previously fine-tune the network prediction model 306). In this regard, the network prediction model 306 may be trained and/or finetuned using data that reflects various dynamics in weather, external traffic pattern, changes in signal transmitter locations, new communication networks/data channels in a given geographical location (geo location), and/or the like. In this regard, the network prediction model 306 may be configured, trained, and/or finetuned using robust and diverse dataset, which in turn, results in improved prediction accuracy of the network prediction model 306.

In some embodiments, generating, configuring, and/or testing the network prediction model 306 comprises evaluating the network prediction model 306 (or associated decision engine) during a testing phase of the framework. As illustrated in FIG. 4, in some embodiments, the network prediction model 306 is evaluated using testing dataset 410. In some embodiments, the testing dataset 410 may be aggregated from data 402 associated with one or more historical aircraft missions. For example, the testing dataset 410 may comprise historical aircraft state dataset for each historical aircraft mission of the one or more historical aircraft missions. As described above, the historical aircraft state dataset associated with an historical aircraft mission may comprise latitude data during the historical aircraft mission, longitude data during the aircraft mission, heading data during the aircraft mission, altitude data during the aircraft mission; contextual weather data during the aircraft mission; operational flight plan for the aircraft mission, operational flight corridor plan for the aircraft mission, signal strength data (e.g., communication network signal strength/data link signal strength) during aircraft mission; and/or other relevant aircraft state data.

As illustrated in FIG. 4, in some embodiments, the network prediction model 306 may be evaluated using testing dataset 410 and a digital twin. For example, a digital twin algorithm 406 may be applied to the training dataset 404 to generate an output that is used along with the testing dataset 410 to evaluate the network prediction model 306 and generate evaluation data 408. As illustrated in FIG. 4, the digital twin algorithm 406 may be applied to the training dataset 404 and the evaluation data 408.

As illustrated in FIG. 4, the prediction output 414 of the network prediction model 306 (e.g., such as optimal communication network prediction 308 output of the network prediction model 306, generated based on input data 412) may be provided as feedback 416 to fine-tune the network prediction model 306. For example, the training dataset 404 may be augmented, modified, or otherwise assembled to include the prediction output 414 based on input data 412 such as the current aircraft state dataset 302, prospective aircraft state dataset 304, current network performance data 312, and/or predicted network performance data set 310 input to the network prediction model 306.

As illustrated in FIG. 4, in some embodiments, the edge environment 426 comprises an edge analytics module 418. In some embodiments, the edge analytics module 418 may comprise a rules engine 422 and an AI/ML engine 420. In some embodiments, the network prediction model 306 may be embodied by the edge analytics module 418. In some embodiments, the AI/ML engine 420 may include or otherwise embody the network prediction model 306. In some embodiments, the network prediction model 306 and/or AI/ML engine 420 may be embodied by the rules engine 422. In some embodiments, the rules engine 422 may be embodied by the AI/ML engine 420. In some embodiments, the edge analytics module 418 (or corresponding edge analytics framework software development kit (SDK)) may be configured such that cloud/server defined rules may be evaluated with various applications against live data traffic. In some examples, the defined rules comprise selection rules. For example, in some embodiments, an edge analytics framework software development kit (SDK) may be built with a wrapper around open source expression engine and the capabilities, as described herein, integrated with end-to-end framework architecture. The various applications may be configured to follow the SDK specification to utilize the rule expressions in their respective application logic. In some embodiments, the implementation may comprise a plug and play (PnP) architecture to attach/detach advanced rules engine to support customized target with little resource footprints. In some embodiments, the computing system 101, using the rules engine, aggregates (e.g., applies appropriate aggregation) continuous timeseries aircraft state data, as described herein, and transmits the timeseries aircraft state data periodically to the AI/ML engine 420 to generate prediction outputs 414 and/or status.

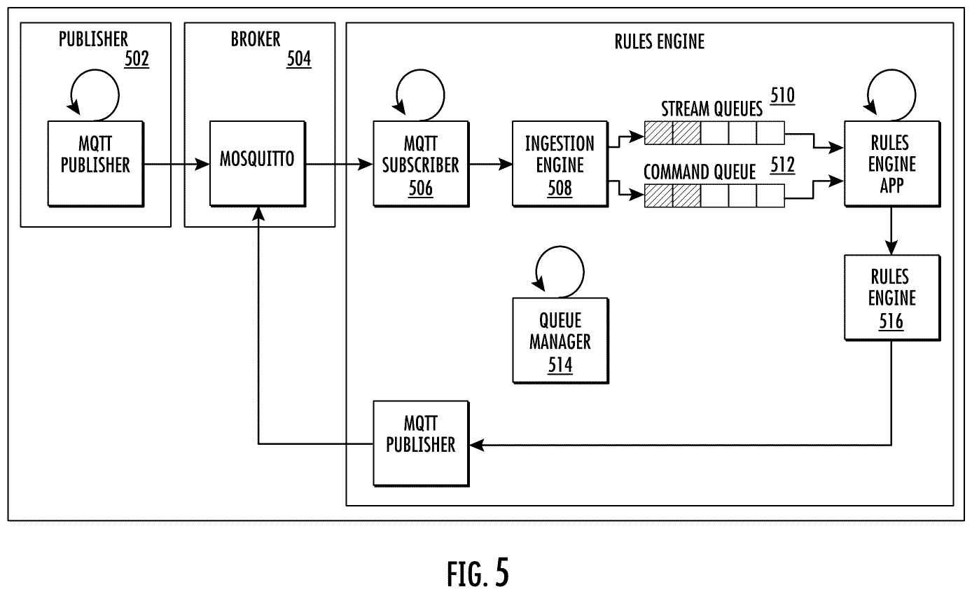

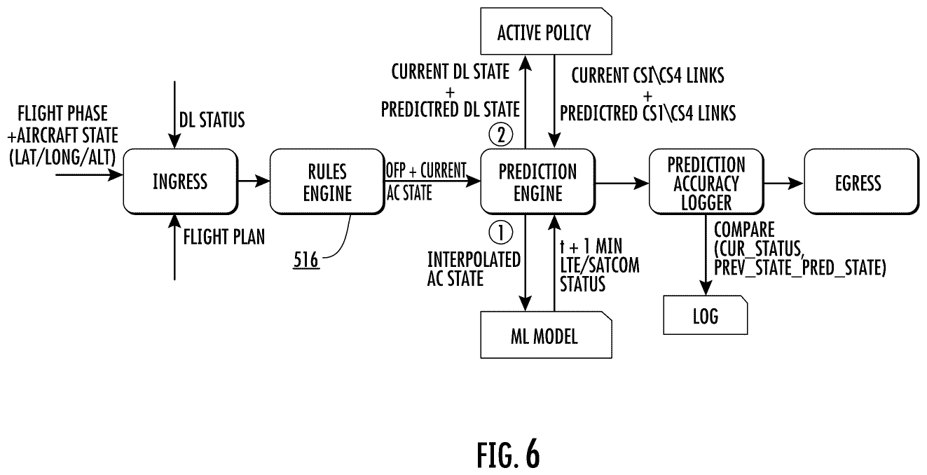

Now referencing FIGS. 5 and 6, a block diagram of an example edge architecture corresponding to edge environment 426 (or edge analytics module 418 thereof) and example data flow is provided in accordance with at least one example embodiment of the present disclosure is provided. In some embodiments, the edge architecture comprises a data publisher 502 configured via hardware, software, firmware, and/or any combination thereof, for sending messages to a broker 504. In some examples the data publisher 502 comprises a message queuing telemetry transport (MQTT) publisher representative of protocol used by the edge analytics module 418 to ingest data. In some embodiments, the architecture includes the broker 504 configured via hardware, software, firmware, and/or any combination thereof, to receive messages from the data publisher 502. For example, data published in MQTT (e.g., MQTT topic) by the data publisher 502 may be pushed or otherwise transmitted to the broker for broadcasting the data to one or more subscribers 506. In some embodiments, the broker 504 comprises MQTT broker. In some embodiments, the architecture includes the one or more subscribers 506. In some embodiments, a subscriber 506 is configured via hardware, software, firmware, and/or any combination thereof, to receive messages from the broker 504. A subscriber 506 may comprise an MQTT subscriber representative of a protocol used by the edge analytics module 418 for subscribing data from the broker 504 under a topic. In this regard, the data publisher 502, broker 504, and/or one or more subscribers 506 may represent components leveraged for data ingestion. For example, data ingestion functionality associated with the edge analytics module 418 may be performed at least in part using the data publisher 502, broker 504, and/or one or more subscribers 506.

The architecture may include an ingestion engine 508 configured via hardware, software, firmware, and/or any combination thereof, to leverage the data publisher 502, broker 504, and/or one or more subscribers 506 to perform data ingestion functions associated with the edge analytics module 418. In some embodiments, the ingestion engine 508 may embody or is otherwise associated with the data publisher 502, broker 504, and/or one or more subscribers 506.

The architecture may include one or more stream queues 510 (e.g., data stream queues) configured via hardware, software, firmware, and/or any combination thereof, to receive data from the ingestion engine 508 as data streams. For example, the ingestion engine 508 may be configured to covert data received from the one or more subscribers 506 into a data stream and push or otherwise transmit the data stream into the one or more stream queues 510.

The architecture may include one or more command queues 512 configured via hardware, software, firmware, and/or any combination thereof, to receive command configured in the cloud environment 424. For example, commands configured in the cloud environment 424 may be processed in the edge environment 426 as commands which are pushed or otherwise transmitted to the one or more command queues 512.

In some embodiments, the architecture includes a queue manager 514 configured via hardware, software, firmware, and/or any combination thereof, to manage the one or more stream queues 510 and/or one or more command queues 512.

In some embodiments, the architecture includes rules engine 516 configured via hardware, software, firmware, and/or any combination thereof to process rules configured in the cloud environment 424 and evaluate the data streams in the one or more stream queues with expressions constructed from the rules. The rules engine 516 may comprise an example implementation of the rules engine 422 described with reference to FIG. 4.

In some embodiments, the rules associated with the rules engine 516 may be configured in the cloud environment 424 (e.g., by cloud manager component comprising hardware, software, firmware, and/or any combination thereof) using GUI-based configuration, expression language-based configuration, or other configuration techniques. Implementation of the expression language-based configuration may involve using python, SQL, and/or plain English script-based language to define conditions and/or thresholds such as, for example: average(aircraft_state) && last(wxr_data) && average(datalink_status).

The rules configured in the cloud manager component may be pushed/transmitted to the edge environment 426 (e.g., edge device) at runtime or may be pulled when the edge environment/edge device boots or connects with cloud manager. In some examples, the rules may define computational operations that are applied to incoming data streams (e.g., from one or more sensors or other devices). In some examples, the rules may comprise selection rules/criteria for selecting an optimal communication network and/or switching to an optimal communication network.

In some embodiments, the rules engine 516 may be configured to process the incoming data streams in a pre-configured periodic interval. In some embodiments, upon receiving the data pushed/transmitted from the data publisher 502, the ingestion engine 508 converts the received data into data stream and transmits the data stream into the one or more stream queues 510 for processing by the rules engine 516. In some embodiments, the rules engine 516 is configured to process the data streams and evaluate it against the rule expressions. In some embodiments, events and/or alarms may be generated when the conditions defined in the rules are satisfied, otherwise data stream will be discarded for the sample taken. In some embodiments, the AI/ML engine 420 is configured to consume or otherwise receive the data stream(s) and publish its prediction on via an egress engine and propagate to other modules (e.g., other CMF module).

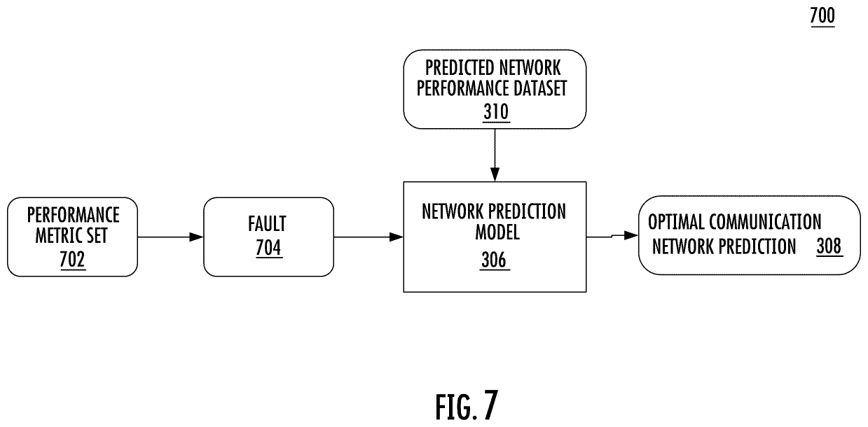

Now referencing FIG. 7, an example data flow 700 presented in accordance with at least one example embodiment of the present disclosure is provided. In some example embodiments, the data structures and processes shown and described with reference to the data flow diagram of FIG. 7 may be generated, performed, or otherwise facilitated by the various systems and apparatuses shown and described with reference to FIGS. 1-2. Using the various elements and techniques described herein, the computing system 101 (e.g., predictive computing device 106 thereof) may be configured to execute a dynamic link connectivity selection process in accordance with at least one example embodiment of the present disclosure.

In some embodiments, the computing system 101 may be configured to predict a fault 704 associated with a communication network. In some examples, the communication network may comprise a communication network that is currently connected to the aircraft. In some examples the communication network may comprise a candidate communication network (e.g., available communication) for connecting to the aircraft but that is not currently connected to the aircraft. In some embodiments, the computing system 101 may be configured to predict a fault 704 associated with the communication network based on a performance metric set 702 associated with the communication network. In some embodiments, the performance metric set 702 comprise current network performance data 312 for the communication network as described above with reference to FIG. 3. For example, the performance metric set 702 may comprise data indicative and/or representative of one or more of signal noise to ratio (SNR) or quality of service (QoS) signal dataset.

In some embodiments, the fault 704 comprises a predicted performance degradation associated with the communication network. In some embodiments, predicting the fault 704 comprises determining that the communication network is associated with a communication integrity score that fails to satisfy an integrity score threshold. In some embodiments, predicting the fault 704 comprises determining that the communication network is associated with a network performance score that fails to satisfy a predetermined network performance threshold. In some embodiments, the network performance score may be indicative and/or representative of the integrity score. In this regard, in some embodiments, the network performance threshold may correspond to the integrity score threshold. In some embodiments, the fault 704 may be associated with one or more components of the communication network. Alternatively or additionally, in some embodiments, the fault 704 may be associated with one or more components connected to the communication network or otherwise determined based one or more components connected to the communication network (e.g., based on performance metrics such as upload speed, download speed, and/or the like with respect to the one or more component). In some examples, the one or more components connected to the communication network may comprise one or more aircraft components or other components onboard an aircraft during an aircraft mission. In some embodiments, predicting the fault 704 comprises performing diagnostics on at least a subset of the one or more components to determine the fault. In some embodiments, predicting the fault 704 comprises receiving a fault indication. For example, the computing system 101 may be configured to receive a fault indication from the aircraft, aircraft component(s), client computing device(s), and/or the external computing device(s), wherein the fault indication indicates a fault with a communication network. In some examples, the fault indication may comprise a communication network identifier that identifies the communication network associated with the fault. Alternatively or additionally, the fault indication may comprise one or more items of data that indicates the type of fault.

In some embodiments, the computing system 101 may be configured to switch or otherwise cause switching of the aircraft to a second communication network of the plurality of communication networks in response to detecting the fault 704. For example, the computing system may be configured to switch the network connectivity for the aircraft from the communication network associated with the fault to a second communication network. In some embodiments, the computing system 101 may be configured to switch the aircraft to the second communication network using a network switching logic as described above with reference to FIG. 3. In some embodiments, the network switching logic may comprise one or more rules/criteria (e.g., selection rules/criteria). In some embodiments, the computing system 101 may determine or otherwise select the second communication network using a network prediction model such as the network prediction model 306. For example, the computing system 101, using the network prediction model 306 may generate, based on predicted network performance dataset 310 associated with one or more communication networks, an optimal communication network prediction 308 that comprises the second communication network. For example, the computing system 101 may be configured to select the optimal communication network from the one or more communication networks by applying the network prediction model 306 to at least a subset of the plurality of communication networks, wherein the network prediction model 306 may be configured, trained, and/or the like to determine the optimal communication network based on or more parameters and/or input. In this regard, the second communication network may correspond to the optimal communication for connecting to the aircraft. For example, the second communication network may serve to provide optimal network connectivity for the aircraft.

In some embodiments, the computing system 101 may be configured to initiate the performance one or more mitigation actions in response to the predicted fault. In some embodiments, initiating the performance one or more mitigation actions comprise generating an alert and transmitting one or more computer-executable instructions configured to transmit the alert to one or more client computing devices and/or the aircraft. In some embodiments, initiating the performance of one or more mitigation actions comprise transmitting one or more computer-executable instructions configured to resolve the fault associated with the first communication network. In some embodiments, initiating the performance of one or more mitigation actions comprises determining one or more recommended solutions for resolving the fault and transmitting the one or more recommended solutions to one or more client computing device and/or the aircraft. In some embodiments, initiating the performance one or more mitigation actions comprises generating an interface comprising data that describes the fault and/or one or more recommended solutions for the fault.

In some embodiments, initiating the performance of one or more mitigation actions comprises transmitting one or more computer-executable instructions configured to switch the network connection of the aircraft from the first communication network to the second communication network identified in the optimal communication network prediction 308. For example, in some embodiments, the computing system 101 may be configured to transmit one or more computer-executable instructions configured to control and/or direct one or more components associated with the aircraft to switch network connection of the aircraft from the first communication network to the second communication network based on, for example, the network switching logic.

In some example implementations one or more pre-configuration and/or implementation steps may be performed. For example, signal parameters, signal profile and signature for generating signals (e.g., 4G, 5G, Satcom, VHF, and/or the like) may be defined. In some example, functional analysis and simulation may be performed to comprehensively run use cases and what if scenarios. In some examples, method(s) for generating signals (e.g., simulation, vector signal transceivers, GPIB, serial, ethernet, and/or the like) may be determined. In some examples, performance metric sets may be predefined for detecting degradation to service (e.g., corresponding to a fault). Such performance metric set may include signal to noise ratio (SNR), quality of service (QoS), and/or the like. In some examples, baseline switching criteria and switching requirements for a ubiquitous and lossless network (e.g., latency, intervals, frequency, hot switch, cold switch, redundancy, priority, integrity, cost, availability etc.) may be determined. A network switching logic may be configured/designed to switch between the communication networks (e.g., cellular, Satcom, and/or the like) available. In some examples, methods to predict cellular or LOS link degradation and failure to allow preemptive sub-net selection (to SATCOM or other G; 5G to 4G) may be determined. In some examples, verification testing may be performed, and success criteria determined. In some examples, predictive interference level by altitude may be performed. For example, as an unmanned aircraft system (UAS) or other aircraft climbs it could see more BSs which may create in-band interference. In some examples, optimal flight height for minimum cellular interference may be determined. In some examples, end to end functional and non-functional requirements—which may be tracked as key performance index (KPIs) for delivery/deployment—may be determined. In some examples, end to end real world testing methodology to demonstrate results and accomplishments may be determined.

### EXAMPLE COMPUTER-IMPLEMENTED PROCESSES/METHODS

Having described example systems, apparatuses, and data architectures in accordance with the present disclosure, example processes in accordance with at least one example embodiment of the present disclosure will now be discussed. In particular, example processes for dynamic link connectivity selection will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

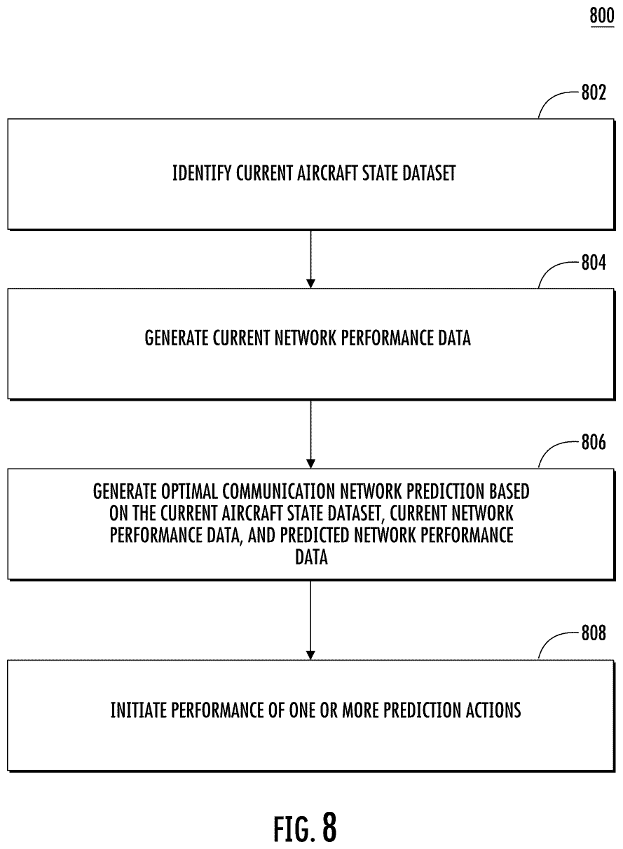

FIG. 8 illustrates an example computer-implemented process 800 for dynamic link connectivity selection in accordance with at least one example embodiment of the present disclosure. The process 800 may be performed by the computing system 101 (described above with respect to FIG. 1).

In some embodiments, the process 800 is embodied by computer program code stored on a non-transitory computer-readable storage medium of a computer program product configured for execution to perform the process as depicted and described. Alternatively, or additionally, in some embodiments, the process 800 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. For purposes of simplifying the description, the process 800 is described as performed by and from the perspective of the apparatus 200.

In some embodiments, the process 800 comprise at operation 802, identifying current aircraft state dataset for an aircraft associated with an aircraft mission. In some embodiments, at least a portion of the current aircraft state dataset comprises position data for the aircraft. In some embodiments, the position data comprises one or more of latitude data, longitude data, altitude data, or heading data. In some embodiments, the position data is received from a navigation system associated with the aircraft. In some embodiments, the navigation system may form part of a larger flight management system. In some embodiments, the current aircraft state dataset comprises a first aircraft state dataset of one or more current aircraft state datasets received during the aircraft mission.

In some embodiments, the process 800 comprise at operation 804, generating current network performance data corresponding to the current aircraft state dataset. In some embodiments, the current network performance data indicates a network connectivity performance of a current communication network associated with the aircraft. In some embodiments, the current network performance data comprises signal-to-noise ratio (SNR) data associated with the current communication network with respect to the aircraft. In some examples, the SNR data comprises SNR score for the current communication network indicative and/or representative of a SNR associated with the communication network at the current time. In some embodiments, the current network performance data comprises quality of service (QoS) data associated with the current communication network with respect to the aircraft. In some examples, the QoS data comprises QoS score for the current communication network indicative and/or representative of a QoS associated with the current communication network at the current time.

In some embodiments, the process 800 comprise at operation 806, generating, using a prediction model, an optimal communication network prediction for a prospective time based on the current aircraft state dataset, the current network performance data, and predicted network performance dataset associated with one or more communication networks. In some embodiments, the optimal communication network prediction comprises a communication network (e.g., optimal communication network) selected from the one or more communication networks as the optimal communication network.

In some embodiments, the optimal communication network may be selected from the one or more communication networks based on the predicted network performance data associated with the selected communication network and/or a set of rules/selection criteria. For example, the selected communication network may comprise a communication network, of the one or more communication networks that satisfies one or more selection rules/criteria and/or associated with a network performance data for the prospective time that satisfies a network performance threshold. In some embodiments, the one or more selection rules/criteria includes satisfying the network performance threshold. In some embodiments, the network performance threshold comprises SNR score threshold. In some embodiments, the network performance threshold comprises QoS score threshold.

In some embodiments, the network prediction model is a machine learning model. In some examples, the network prediction model comprise one or more machine learning algorithms such as one or more of decision tree algorithm(s), naive bayes algorithm(s), support vector machine (SVM) algorithm(s), K-nearest neighbors (KNN) algorithm(s), support vector regression (SVR) algorithm(s), random forest (RF) algorithm(s), adaptive boosting (AdaBoost) algorithm(s), gradient boosting algorithm(s) such as gradient tree boosting (GTB), and/or other machine learning algorithms.

In some embodiments, the predicted network performance dataset comprises predicted network performance data for each of one or more communication networks. For example, a first predicted network performance data from the predicted network performance dataset may comprise SNR data associated with a communication network that is different from the current communication network. In some embodiments, the one or more communication networks includes the current communication network.

In some embodiments, the process 800 comprise at operation 808, initiating the performance of one or more prediction-based actions based on the optimal communication network prediction 308. In some embodiments, initiating the performance of the one or more actions comprises causing switching of the network connection of the aircraft from the current communications network to the optimal communication network identified by the optimal communication network prediction. In some embodiments, the apparatus 200 may be configured to switch or cause switching of the aircraft to the optimal communication network of the one or more communication networks in response to determining that the optimal communication network is different from the current communication network. In some embodiments, the apparatus 200 may be configured to switch or cause switching of the aircraft to the optimal communication network using a network switching logic. For example, the apparatus 200 may be configured to transmit one or more computer-executable instructions configured to control and/or direct one or more components associated with the aircraft to switch network connection of the aircraft from the current communication network to the optimal communication network identified by the optimal communication network prediction in response to determining that the optimal communication network is different from the current communication network and/or using a network switching logic.

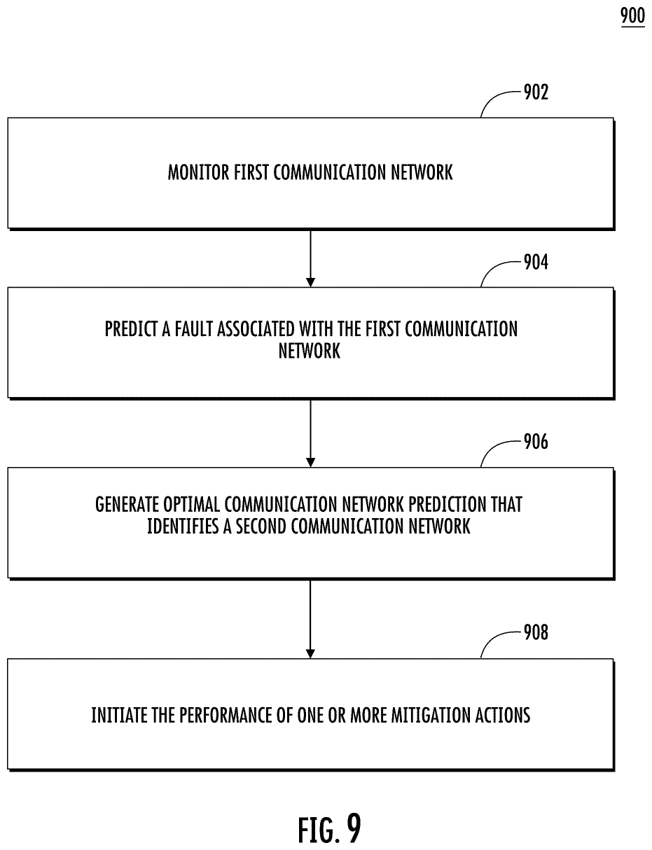

FIG. 9 illustrates an example computer-implemented process 900 for dynamic link connectivity selection in accordance with at least one example embodiment of the present disclosure. The process 900 may be performed by the computing system 101 (described above with respect to FIG. 1).

In some embodiments, the process 900 is embodied by computer program code stored on a non-transitory computer-readable storage medium of a computer program product configured for execution to perform the process as depicted and described. Alternatively, or additionally, in some embodiments, the process 900 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. For purposes of simplifying the description, the process 900 is described as performed by and from the perspective of the apparatus 200.

In some embodiments, the process 900 comprise at operation 902, monitoring a first communication network of one or more communication networks associated with an aircraft. For example, in some embodiments, the apparatus 200 may monitor a first communication network that the aircraft is connected to. In some embodiments, the apparatus 200 may monitor each of the one or more communication networks. In some embodiments, the client computing device may be associated with a vehicle system. For example, in some embodiments, the aircraft may comprise an urban air mobility system or an unmanned system. Examples of a communication network includes cellular communication network, Satcom communication network, and/or the like. In some embodiments, the one or more communication networks comprises cellular, Satcom, or line communication network.

In some embodiments, the process 900 comprise at operation 904, predicting a fault associated with the first communication network. For example, the apparatus 200 may predict a fault associated with the first communication network based on a performance metric set associated with the first communication network. In some embodiments, the performance metric set comprise one or more of SNR or QoS.

In some embodiments, the fault comprises a predicted performance degradation associated with the first communication network. In some embodiments, predicting the fault comprises determining that the first communication network is associated with a communication integrity score that fails to satisfy an integrity score threshold.

In some embodiments, the process 900 comprise at operation 906, switching network connectivity of the aircraft from the first communication network to a second communication network of the one or more communication networks in response to detecting the fault. For example, the apparatus 200 may switch or cause switching of the aircraft to a second communication network of the one or more communication networks in response to detecting the fault. In some embodiments, the apparatus 200 may switch the client computing device to the second communication network using a switching logic. The second communication may correspond to the optimal communication for connecting to the aircraft. For example, the apparatus 200 may select the second communication network from the one or more communication networks by applying the network prediction model to at least a subset of the plurality of communication networks to select an optimal communication network for connecting to the aircraft. The network prediction model may be configured to determine the optimal communication network based on or more parameters (e.g., input). For example, the network prediction model may be configured to determine the optimal communication network based on predicted network performance dataset associated with the one or more communication networks. In this regard, in some embodiments, the one or more parameters may include the performance metric set (e.g., predicted performance data) associated with a respective communication network. Alternatively, or additionally, the one or more parameters may include cost, availability, and/or the like. In some embodiments, apparatus 200 may augment the first communication network with the second communication network in response to detecting the fault.

In some embodiments, the process 900 comprises at operation 908, initiating the performance one or more mitigation actions in response to the predicted fault. For example, the apparatus 200 may perform one or more mitigation actions in response to the predicted fault. In some embodiments, initiating the performance one or more mitigation actions comprise generating an alert and transmitting one or more computer-executable instructions configured to transmit the alert to one or more client computing devices. In some embodiments, initiating the performance of one or more mitigation actions comprise transmitting one or more computer-executable instructions configured to resolve the fault associated with the first communication network. In some embodiments, initiating the performance one or more mitigation actions comprises determining one or more recommended solutions for resolving the fault and transmitting the one or more recommended solutions to one or more client computing device. In some embodiments, initiating the performance one or more mitigation actions comprises generating an interface comprising data that describes the fault and/or one or more recommended solutions for the fault.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying, by one or more processors, current aircraft state dataset for an aircraft associated with an aircraft mission, wherein at least a portion of the current aircraft state dataset comprises position data for the aircraft;
generating, by one or more processors, current network performance data corresponding to the current aircraft state dataset, wherein the current network performance data indicates a network connectivity performance of a current communication network associated with the aircraft;
generating, by the one or more processors and using a network prediction model, an optimal communication network prediction for a prospective time based on the current aircraft state dataset, the current network performance data, and predicted network performance dataset associated with one or more communication networks; and
initiating, by the one or more processors, performance one or more prediction-based actions based on the optimal communication network prediction.

2. The computer-implemented method of claim 1, wherein the position data comprises one or more of latitude data, longitude data, altitude data, or heading data.

3. The computer-implemented method of claim 1, wherein the current network performance data comprises signal-to-noise ratio (SNR) data associated with the current communication network with respect to the aircraft.

4. The computer-implemented method of claim 1, wherein the current network performance data comprises quality of service (QoS) data associated with the current communication network with respect to the aircraft.

5. The computer-implemented method of claim 1, wherein the optimal communication network prediction comprises an optimal communication network selected from the one or more communication networks, wherein the optimal communication network satisfies one or more selection rules.

6. The computer-implemented method of claim 1, wherein the optimal communication network prediction comprises an optimal communication network selected from the one or more communication networks and is associated with a network performance data that satisfies a network performance threshold.

7. The computer-implemented method of claim 1, wherein the network prediction model is a machine learning model.

8. The computer-implemented method of claim 1, wherein a first predicted network performance data from the predicted network performance dataset comprises SNR data associated with a communication network that is different from the current communication network.

9. The computer-implemented method of claim 1, wherein initiating the performance of the one or more prediction-based actions comprises causing switching of network connection of the aircraft from the current communication network to an optimal communication network identified by the optimal communication network prediction.

10. The computer-implemented method of claim 1, wherein the position data is received from a navigation system associated with the aircraft.

11. The computer-implemented method of claim 1, wherein the current aircraft state dataset comprises a first aircraft state dataset of one or more current aircraft state datasets received during the aircraft mission.

12. An apparatus comprising at least one processor and at least one memory storing instructions that, when executed by the at least one processor, cause the apparatus to:
identify current aircraft state dataset for an aircraft associated with an aircraft mission, wherein at least a portion of the current aircraft state dataset comprises position data for the aircraft;
generate current network performance data corresponding to the current aircraft state dataset, wherein the current network performance data indicates a network connectivity performance of a current communication network associated with the aircraft;
generate using a network prediction model, an optimal communication network prediction for a prospective time based on the current aircraft state dataset, the current network performance data, and predicted network performance dataset associated with one or more communication networks; and
initiate performance one or more prediction-based actions based on the optimal communication network prediction.

13. The apparatus of claim 12, wherein the position data comprises one or more of latitude data, longitude data, altitude data, or heading data.

14. The apparatus of claim 12, wherein the current network performance data comprises signal-to-noise ratio (SNR) data associated with the current communication network with respect to the aircraft.

15. The apparatus of claim 12, wherein the current network performance data comprises quality of service (QoS) data associated with the current communication network with respect to the aircraft.

16. The apparatus of claim 12, wherein the optimal communication network prediction comprises an optimal communication network selected from the one or more communication networks, wherein the optimal communication network satisfies one or more selection rules.

17. The apparatus of claim 12, wherein the optimal communication network prediction comprises an optimal communication network selected from the one or more communication networks and is associated with a network performance data that satisfies a network performance threshold.

18. The apparatus of claim 12, wherein the network prediction model is a machine learning model.

19. The apparatus of claim 12, wherein a first predicted network performance data from the predicted network performance dataset comprises SNR data associated with a communication network that is different from the current communication network.

20. At least one non-transitory computer-readable storage medium, the at least one non-transitory computer-readable storage medium having computer coded instructions configured to, when executed by at least one processor:
identify current aircraft state dataset for an aircraft associated with an aircraft mission, wherein at least a portion of the current aircraft state dataset comprises position data for the aircraft;
generate current network performance data corresponding to the current aircraft state dataset, wherein the current network performance data indicates a network connectivity performance of a current communication network associated with the aircraft;
generate using a network prediction model, an optimal communication network prediction for a prospective time based on the current aircraft state dataset, the current network performance data, and predicted network performance dataset associated with one or more communication networks; and
initiate performance one or more prediction-based actions based on the optimal communication network prediction.
